(19) United States
(12) Patent Application Publication
(10) Pub. No.: US 2025/0253896 A1
(43) Pub. Date: Aug. 7, 2025

(54) RADIOFREQUENCY DEVICE AND METHOD USING A DIGITALLY CONTROLLABLE SCATTERER (DCS)

(71) Applicant: HUAWEI TECHNOLOGIES CO., LTD., Shenzhen (CN)

(72) Inventors: Sami Mekki, Boulogne Billancourt (FR); Mustapha Amara, Boulogne Billancourt (FR); Mohamed Kamoun, Boulogne Billancourt (FR); Melissa Duarte Gelvez, Boulogne Billancourt (FR)

(73) Assignee: HUAWEI TECHNOLOGIES CO., LTD., Shenzhen (CN)

(21) Appl. No.: 19/188,896

(22) Filed: Apr. 24, 2025

Related U.S. Application Data
(63) Continuation of application No. PCT/EP2022/079563, filed on Oct. 24, 2022.

(51) Int. Cl. H04B 7/04; H01Q 3/46

(52) U.S. Cl. CPC H04B 7/04013; H01Q 3/46

(57) ABSTRACT

The disclosure provides a radio frequency device, comprising a DCS with a surface that comprises scattering elements having a controllable phase shift, a transmitter configured to transmit an electromagnetic wave onto the scattering surface of the DCS, and a DCS controller. The DCS controller determines a codeword based on one or more parameters of the DCS, a characteristic of the electromagnetic wave transmitted by the transmitter and a characteristic of a desired electromagnetic wave scattered by the scattering surface of the DCS 102. The codeword determines a phase shift configuration for the plurality of scattering elements of the scattering surface of the DCS. Then, the DCS controller controls, using the codeword, the scattering elements of the scattering surface of the DCS to form the desired electromagnetic wave by scattering the electromagnetic wave transmitted by the transmitter.

### CROSS-REFERENCE TO RELATED APPLICATIONS

This application is a continuation of International Application No. PCT/EP2022/079563, filed on Oct. 24, 2022, the disclosure of which is hereby incorporated by reference in its entirety.

### TECHNICAL FIELD

The disclosure relates to radio frequency devices and systems using a digitally controllable scatterer (DCS). The disclosure provides a radiofrequency apparatus for forming a desired electromagnetic wave from an impinging wave using a codeword. A corresponding method and a computer program product are also provided.

### BACKGROUND

Electromagnetic systems have gained a lot of interest in a wide range of domains in addition to conventional use in wireless communication systems, such as RADAR, LIDAR, sensing, movement and object detection, imaging and holography, among others.

The large increase in the use of radio waves in a wide variety of fields with diverse applications originates essentially from the advances in harnessing radio waves and their propagation and interaction with the propagation environment. The control of propagated electromagnetic waves within a propagation environment became more efficient as a result of the multiplication of transmit and receive antennas. This was made possible due to channel estimation and the acquisition of channel state information. This technique consists in estimating the propagation medium, in order to properly shape the radiation patterns of the receive antennas and transmit antennas to the estimated propagation medium with respect to the intended application.

Recently, adapting the propagation medium to the needs of the intended application has started to be considered. This concept, known as channel programming, consists in introducing passive reflecting or scattering elements in the propagation environment, in order to shape the propagation medium, known as propagation channel.

Passive or semi passive reflective surfaces, known as Reflective Intelligent Surface (RIS), Large Intelligent Surface (LIS) or Digitally Controllable Scatterer (DCS), are essentially very large surfaces composed of a large number (e.g., hundreds or thousands) of scattering elements with a controllable phase shift that can be tuned to change the perceived propagation channel between two communicating nodes, wherein one node is a transmitter (or source) and the other node is a receiver (or target).

Inherited from communication tools, the processing and selection of the phase shifts that need to be applied to the different scattering elements composing a DCS is based on signal processing techniques through a channel estimation process. Several solutions have been proposed in this regard. Nevertheless, the practical implementation of these solutions is very difficult to achieve, since they require huge computational complexity, significant time to converge and, notably, present an exponential complexity with respect to the number of scattering elements composing the DCS surfaces.

Defining a codeword, i.e., the proper phase configuration to be applied to the scattering elements of a DCS, may be based on channel state information collection and, then, adapting the DCS to a given constraint on the received signals based on the propagation channel and the contribution of the DCS.

Furthermore, codeword representation, storage and exchange require information of a large number of values that is equal to the number of scattering elements of the DCS.

In addition, conventional codeword generation methods are not harmonized for different wavefront manipulations. That is, conventional codewords are only designed for far-field impinging wavefront (plane wave) to far-field scattered wavefront (plane wave), or are only designed for near-field impinging wavefront (spherical wave) to near-field scattered wavefront (spherical wave).

### SUMMARY

In view of the above, this disclosure aims to improve the conventional solutions for devices using a DCS. An objective is to enable an optimal configuration for the scattering elements of a DCS, i.e. codeword, in order to fulfill a transformation or filtering functionality on the electromagnetic wavefronts. In other words, solutions according to the present disclosure aim to enable a configuration of the phases of the scattering elements of a DCS based on an impinging electromagnetic wave generated by the source and a desired outgoing electromagnetic wave, for the intended application and the target. In other words, this disclosure proposes a generalized and systematic procedure to generate a codeword for the DCS.

This and other objectives are achieved by this disclosure according to the solutions described in the independent claims. Advantageous implementations are further described in the dependent claims.

A first aspect of this disclosure provides a radio frequency device including: a DCS comprising a scattering surface that comprises a plurality of scattering elements, each having a controllable phase shift; a transmitter configured to transmit an electromagnetic wave onto the scattering surface of the DCS; and a DCS controller configured to determine a codeword based on one or more parameters of the DCS, a characteristic of the electromagnetic wave transmitted by the transmitter, and a characteristic of a desired electromagnetic wave scattered by the scattering surface of the DCS; and control the scattering elements of the scattering surface of the DCS, using the codeword, to form the desired electromagnetic wave by scattering the electromagnetic wave transmitted by the transmitter. The codeword determines a phase shift configuration for the plurality of scattering elements of the scattering surface of the DCS.

This provides the advantage of configuring and controlling a DCS to generate an electromagnetic signal that can be applied for different scenarios, applications and configurations. In other words, the radio frequency device according to this disclosure is able to configure the surface of the DCS in a controlled manner in order to manipulate propagating electromagnetic waves emitted by the transmitter, and to scatter them as desired, for example towards a region of interest or towards a target.

Further advantageously, the radio frequency device according to this disclosure may provide a direct generation of a compressed codeword with a few parameters, thereby reducing computational complexity and further reducing the codeword storage and exchange between the different components of the radio frequency device. Further, such a compressed codeword can be seen as explicitly eliminating the characteristic of the DCS; hence, getting a higher level of abstraction (that is, a generalized version of the codeword) that can be decompressed, i.e., adapted to the DCS, by accounting for its characteristics.

In this disclosure, the codeword generation refers to the construction and configuration of the phase shift for each of the scattering elements of the DCS.

Further, in this disclosure, the terms wave and wavefront may be used interchangeably. Further, the terms electromagnetic signal and electromagnetic wave/wavefront may also be used interchangeably.

Notably, while the radio frequency device of the first aspect includes the transmitter, the transmitter does not have to be a part of the radio frequency device, i.e., the radio frequency device does not have to include the transmitter.

In an implementation form of the first aspect, the characteristic of the electromagnetic wave transmitted by the transmitter comprises at least one of a propagation vector and a structure of the electromagnetic wave transmitted by the transmitter.

In this disclosure, the characteristic of the electromagnetic wave transmitted by the transmitter, which is taken into account by the DCS controller, means the characteristic of that electromagnetic wave at the DCS, i.e., as it impinges on the scattering surface of the DCS (after a channel between transmitter and DCS).

Optionally, also the characteristic of the electromagnetic wave at the transmitter (before the channel between transmitter and DCS) could be taken into account by the DCS controller. For example, the characteristic of the electromagnetic wave impinging at the scattering surface of the DCS could be determined from the characteristic of the electromagnetic wave at the transmitter by using a transfer function, wherein the transfer function is based on knowledge of the channel between the transmitter and the DCS.

In an implementation form of the first aspect, the characteristic of the desired electromagnetic wave scattered by the scattering surface of the DCS comprises at least one of a desired propagation vector and a structure of the desired electromagnetic wave scattered by the scattering surface of the DCS.

In an implementation form of the first aspect, the one or more parameters of the DCS comprise at least one of a position of the DCS, an orientation of the DCS, a size of each of the scattering elements of the scattering surface of the DCS, and a total number of the scattering elements of the scattering surface of the DCS.

By considering the characteristic of both the electromagnetic wave transmitted by the transmitter and the desired electromagnetic wave scattered by the DCS, as well as the parameters of the DCS itself, all possible scenarios (near field and/or far field) can be considered when generating the codeword.

In an implementation form of the first aspect, the DCS controller is further configured to determine the characteristic of the electromagnetic wave transmitted by the transmitter, or to obtain the characteristic of the electromagnetic wave transmitted by the transmitter by signaling from the transmitter. Additionally or alternatively, the DCS controller is further configured to determine the characteristic of the desired electromagnetic wave scattered by the scattering surface of the DCS, or to obtain the characteristic of the desired electromagnetic wave scattered by the scattering surface of the DCS by signaling from the transmitter.

This provides the advantage that complexity and exchange of information between the different components of the radio frequency device can be reduced.

In an implementation form of the first aspect, a position of the transmitter and a position and orientation of the DCS are fixed relative to each other.

In an implementation form of the first aspect, the DCS controller is further configured to: determine, based on a quadric surface Q that behaves as a perfect electric conductor, PEC, based on the characteristic of the electromagnetic wave transmitted by the transmitter and based on the characteristic of the desired electromagnetic wave scattered by the scattering surface of the DCS, an optimal quadric surface Q* that describes a transformation of the electromagnetic wave transmitted by the transmitter to form the desired electromagnetic wave scattered by the scattering surface of the DCS; and determine a phase shift for each of the scattering elements of the scattering surface of the DCS as a function of one or more parameters of the optimal quadric surface Q*.

In this disclosure, the codeword may be tailored based on the reflection properties of a quadric surface and its parameters that describe the required or desired transformation to be applied, by the surface of the DCS, on the electromagnetic wave transmitted to the DCS, and then mapping the behavior of the quadric reflecting surface to the DCS. This mapping may comprise determining the phase shift for each of the scattering elements of the surface of the DCS, such that the wave scattered by the DCS is the same as if it was reflected by a mirror having the quadric shape.

As a result, the codeword may be compressed in a minimal number of parameters that would be at most the number of parameters defining the identified quadric. Further advantageously, the generated codeword may encode the phase shifts that need to be applied to each of the scattering elements of the DCS individually, in order to form the desired electromagnetic wave scattered by the DCS.

In addition, several codewords and a codebook (a collection of codewords) can be generated on the fly based on quadric expressions.

In an implementation form of the first aspect, the quadric surface Q has a canonical equation:

$${( - 1 )}^{{α}_{2}} {( \frac{x}{a} )}^{{α}_{1}} + {( - 1 )}^{{β}_{2}} {( \frac{y}{b} )}^{{β}_{1}} + {( - 1 )}^{{γ}_{2}} {( \frac{z}{c} )}^{{γ}_{1}} = {( - 1 )}^{τ} d ,$$

where a, b, c, d, α₁, α₂, β₁, β₂, γ₁, γ₂, and τ, are parameters of the quadric surface Q, with α₂, β₂, γ₂, τ∈{0,1}.

In this disclosure, the term quadric surface is used to refer to both, a conic in 2D or a quadric surface in 3D.

In an implementation form of the first aspect, the DCS controller is further configured to determine the phase shift for each of the scattering elements of the scattering surface of the DCS based on a minimum distance between the optimal quadric surface Q* and the scattering surface of the DCS.

In an implementation form of the first aspect, the codeword indicates the determined phase shift for each of the scattering elements of the scattering surface of the DCS such that controlling the scattering elements of the scattering surface of the DCS, using the codeword, scatters the electromagnetic wave transmitted by the transmitter according to a reflection of the quadric surface.

In an implementation form of the first aspect, the radio frequency device further comprises a target that is illuminated by the desired electromagnetic wave scattered by the scattering surface of the DCS.

In an implementation form of the first aspect, the target is a receiver configured to receive the desired electromagnetic wave scattered by the scattering surface of the DCS.

In an implementation form of the first aspect, the DCS controller is further configured to obtain the characteristic of the desired electromagnetic wave scattered by the scattering surface of the DCS by signaling from the target. Alternatively, the DCS controller is further configured to obtain the characteristic of the desired electromagnetic wave scattered by the scattering surface of the DCS by using information about the target.

By considering also a target and/or receiver, the versatility of the proposed radio frequency device may be enhanced by enabling different configurations and by increasing the range of possible applications, including for example beam focusing, single and multi-user focusing, hologram, sensing and the like.

A second aspect of this disclosure provides a radio frequency device including: a DCS comprising a scattering surface that comprises a plurality of scattering elements, each having a controllable phase shift, and a DCS controller. The DCS controller is configured to determine a codeword based on one or more parameters of the DCS, a characteristic of an electromagnetic wave impinging onto the scattering surface of the DCS, and a characteristic of a desired electromagnetic wave scattered by the scattering surface of the DCS; and control the scattering elements of the scattering surface of the DCS, using the codeword, to form the desired electromagnetic wave by scattering the electromagnetic wave impinging onto the scattering surface of the DCS. The codeword determines a phase shift configuration for the plurality of scattering elements of the scattering surface of the DCS.

The electromagnetic wave impinging onto the scattering surface of the DCS can be generated by, for example but not limited to, a transmitter.

This provides the advantage of configuring and controlling a DCS to generate, based on an impinging wave, an electromagnetic wave that can be applied for different scenarios, applications and configurations. In other words, the radio frequency device according to this disclosure is able to configure the surface of the DCS in a controlled manner in order to manipulate propagating electromagnetic waves that impinge onto it, and to scatter the impinging electromagnetic waves as desired, for example, towards a region of interest or towards a target.

Further advantageously, the radio frequency device according to this disclosure may provide a direct generation of a compressed codeword with only few parameters, thereby reducing computational complexity and further reducing the codeword storage and exchange between the different components of the radio frequency device. Further, such a compressed codeword can be seen as explicitly eliminating the characteristic of the DCS; hence, getting a higher level of abstraction (that is, a generalized version of the codeword) that can be decompressed, i.e., adapted to the DCS, by accounting for its characteristics.

In this disclosure, the codeword generation refers to the construction and configuration of the phase shift for each of the scattering elements of the DCS.

In an implementation form of the second aspect, the characteristic of the electromagnetic wave impinging onto the scattering surface of the DCS comprises at least one of a propagation vector and a structure of the electromagnetic wave impinging onto the scattering surface of the DCS.

In an implementation form of the second aspect, the characteristic of the desired electromagnetic wave scattered by the scattering surface of the DCS comprises at least one of a desired propagation vector and a structure of the desired electromagnetic wave scattered by the scattering surface of the DCS.

In an implementation form of the second aspect, the one or more parameters of the DCS comprise at least one of a position of the DCS, an orientation of the DCS, a size of each of the scattering elements of the scattering surface of the DCS, and a total number of the scattering elements of the scattering surface of the DCS.

By considering the characteristic of both the electromagnetic wave impinging onto the DCS and the desired electromagnetic wave scattered by the DCS, as well as the parameters of the DCS itself, all possible scenarios (near field and/or far field) can be considered when generating the codeword.

In an implementation form of the second aspect, the DCS controller is further configured to determine the characteristic of the electromagnetic wave impinging onto the scattering surface of the DCS. Additionally or alternatively, the DCS controller is further configured to determine the characteristic of the desired electromagnetic wave scattered by the scattering surface of the DCS.

In an implementation form of the second aspect, the DCS controller is further configured to: determine, based on a quadric surface Q that behaves as a perfect electric conductor, PEC, based on the characteristic of the electromagnetic wave impinging onto the scattering surface of the DCS and based on the characteristic of the desired electromagnetic wave scattered by the scattering surface of the DCS, an optimal quadric surface Q* that describes a transformation of the electromagnetic wave impinging onto the scattering surface of the DCS to form the desired electromagnetic wave scattered by the scattering surface of the DCS; and determine a phase shift for each of the scattering elements of the scattering surface of the DCS as a function of one or more parameters of the optimal quadric surface Q*.

In this disclosure, the codeword may be tailored based on the reflection properties of a quadric surface and its parameters that describe the required or desired transformation to be applied, by the surface of the DCS, on the electromagnetic wave impinging onto the DCS, and then mapping the behavior of the quadric reflecting surface to the DCS. This mapping may comprise determining the phase shift for each of the scattering elements of the surface of the DCS, such that the wave scattered by the DCS is the same as if it was reflected by a mirror having the quadric shape.

As a result, the codeword may be compressed in a minimal number of parameters that would be at most the number of parameters defining the identified quadric. Further advantageously, the generated codeword may encode the phase shifts that need to be applied to each of the scattering elements of the DCS individually, in order to form the desired electromagnetic wave scattered by the DCS.

In addition, several codewords and a codebook (a collection of codewords) can be generated on the fly based on quadric expressions.

In an implementation form of the second aspect, the quadric surface Q has a canonical equation:

$${( - 1 )}^{{α}_{2}} {( \frac{x}{a} )}^{{α}_{1}} + {( - 1 )}^{{β}_{2}} {( \frac{y}{b} )}^{{β}_{1}} + {( - 1 )}^{{γ}_{2}} {( \frac{z}{c} )}^{{γ}_{1}} = {( - 1 )}^{τ} d ,$$

where a, b, c, d, α₁, α₂, β₁, β₂, γ₁, γ₂, and τ, are parameters of the quadric surface Q, with α₂, β₂, γ₂, τ∈{0,1}.

In an implementation form of the second aspect, the DCS controller is further configured to determine the phase shift for each of the scattering elements of the scattering surface of the DCS based on a minimum distance between the optimal quadric surface Q* and the scattering surface of the DCS.

In an implementation form of the second aspect, the codeword indicates the determined phase shift for each of the scattering elements of the scattering surface of the DCS such that controlling the scattering elements of the scattering surface of the DCS, using the codeword, scatters the electromagnetic wave impinging onto the DCS according to a reflection of the quadric surface.

A third aspect of this disclosure provides a radio frequency method comprising: transmitting, from a transmitter, an electromagnetic wave onto a scattering surface of a DCS, that comprises a plurality of scattering elements each having a controllable phase shift; determining, by a DCS controller, a codeword based on one or more parameters of the DCS, a characteristic of the electromagnetic wave transmitted by the transmitter, and a characteristic of a desired electromagnetic wave scattered by the scattering surface of the DCS; and controlling, by the DCS controller, the scattering elements of the scattering surface of the DCS, using the codeword, to form the desired electromagnetic wave by scattering the electromagnetic wave transmitted by the transmitter. The codeword determines a phase shift configuration for the plurality of scattering elements of the scattering surface of the DCS.

In an implementation form of the third aspect, the characteristic of the electromagnetic wave transmitted by the transmitter comprises at least one of a propagation vector and a structure of the electromagnetic wave transmitted by the transmitter.

In an implementation form of the third aspect, the characteristic of the desired electromagnetic wave scattered by the scattering surface of the DCS comprises at least one of a desired propagation vector and a structure of the desired electromagnetic wave scattered by the scattering surface of the DCS.

In an implementation form of the third aspect, the one or more parameters of the DCS comprise at least one of a position of the DCS, an orientation of the DCS, a size of each of the scattering elements of the scattering surface of the DCS, and a total number of the scattering elements of the scattering surface of the DCS.

By considering the characteristic of both the electromagnetic wave transmitted by the transmitter and the desired electromagnetic wave scattered by the DCS, as well as the parameters of the DCS itself, all possible scenarios (near field and/or far field) can be considered when generating the codeword.

In an implementation form of the third aspect, the method further comprises determining, by the DCS controller, the characteristic of the electromagnetic wave transmitted by the transmitter, or to obtain the characteristic of the electromagnetic wave transmitted by the transmitter by signaling from the transmitter. Additionally or alternatively, determining, by the DCS controller, the characteristic of the desired electromagnetic wave scattered by the scattering surface of the DCS, or obtaining, by the DCs controller, the characteristic of the desired electromagnetic wave scattered by the scattering surface of the DCS by signaling from the transmitter.

This provides the advantage that complexity and exchange of information between the different components of the radio frequency device can be reduced.

In an implementation form of the third aspect, a position of the transmitter and a position and orientation of the DCS are fixed relative to each other.

In an implementation form of the third aspect, the method further comprises determining, by the DCS controller, based on a quadric surface Q that behaves as a perfect electric conductor, PEC, based on the characteristic of the electromagnetic wave transmitted by the transmitter and based on the characteristic of the desired electromagnetic wave scattered by the scattering surface of the DCS, an optimal quadric surface Q* that describes a transformation of the electromagnetic wave transmitted by the transmitter to form the desired electromagnetic wave scattered by the scattering surface of the DCS; and determining, by the DCS controller, a phase shift for each of the scattering elements of the scattering surface of the DCS as a function of one or more parameters of the optimal quadric surface Q*.

In this disclosure, the codeword may be tailored based on the reflection properties of a quadric surface and its parameters that describe the required or desired transformation to be applied, by the surface of the DCS, on the electromagnetic wave transmitted to the DCS, and then mapping the behavior of the quadric reflecting surface to the DCS. This mapping may comprise determining the phase shift for each of the scattering elements of the surface of the DCS, such that the wave scattered by the DCS is the same as if it is being reflected by a mirror having the quadric shape.

As a result, the codeword may be compressed in a minimal number of parameters that would be at most the number of parameters defining the identified quadric. Further advantageously, the generated codeword may encode the phase shift that need to be applied to each of the scattering elements of the DCS individually in order to form the desired electromagnetic wave scattered by the DCS.

In addition, several codewords and a codebook (a collection of codewords) can be generated on the fly based on quadric expressions.

In an implementation form of the third aspect, the quadric surface Q has a canonical equation:

$${( - 1 )}^{{α}_{2}} {( \frac{x}{a} )}^{{α}_{1}} + {( - 1 )}^{{β}_{2}} {( \frac{y}{b} )}^{{β}_{1}} + {( - 1 )}^{{γ}_{2}} {( \frac{z}{c} )}^{{γ}_{1}} = {( - 1 )}^{τ} d ,$$

where a, b, c, d, α₁, α₂, β₁, β₂, γ₁, γ₂, and τ, are parameters of the quadric surface Q, with α₂, β₂, γ₂, τ∈{0,1}.

In an implementation form of the third aspect, the method further comprises determining, by the DCS controller, the phase shift for each of the scattering elements of the scattering surface of the DCS based on a minimum distance between the optimal quadric surface Q* and the scattering surface of the DCS.

In an implementation form of the third aspect, the codeword indicates the determined phase shift for each of the scattering elements of the scattering surface of the DCS such that controlling the scattering elements of the scattering surface of the DCS, using the codeword, scatters the impinging electromagnetic wave emitted by the source according to a reflection by the quadric surface.

In an implementation form of the third aspect, the method further comprises illuminating a target by the desired electromagnetic wave scattered by the scattering surface of the DCS.

In an implementation form of the third aspect, the method further comprises receiving, by the target, the desired electromagnetic wave scattered by the scattering surface of the DCS, where the target is a receiver.

In an implementation form of the third aspect, the method further comprises obtaining, by the DCS controller, the characteristic of the desired electromagnetic wave scattered by the scattering surface of the DCS by signaling from the target. Alternatively, the method comprises obtaining, by the DCS controller, the characteristic of the desired electromagnetic wave scattered by the scattering surface of the DCS by using information about the target and the application.

The method of the third aspect and its implementation forms achieve the same advantages as described above for the device of the first aspect and its respective implementation forms.

A fourth aspect of this disclosure provides a radio frequency method including: determining, by a DCS controller, a codeword based on one or more parameters of a DCS, the DCS comprising a scattering surface that comprises a plurality of scattering elements each having a controllable phase shift, based on a characteristic of an electromagnetic wave impinging onto the scattering surface of the DCS, and based on a characteristic of a desired electromagnetic wave scattered by the scattering surface of the DCS; and controlling, by the DCS controller, the scattering elements of the scattering surface of the DCS, using the codeword, to form the desired electromagnetic wave by scattering the electromagnetic wave impinging onto the scattering surface of the DCS. The codeword determines a phase shift configuration for the plurality of scattering elements of the scattering surface of the DCS.

The electromagnetic wave impinging onto the scattering surface of the DCS can be generated by, for example but not limited to, a transmitter.

The method of the fourth aspect and its implementation forms achieve the same advantages for the device of the second aspect and its respective implementation forms.

A fifth aspect of this disclosure provides a computer program product comprising a program code for carrying out, when implemented on a processor, the method according to the third aspect or its implementation forms.

A sixth aspect of this disclosure provides a computer program product comprising a program code for carrying out, when implemented on a processor, the method according to the fourth aspect or its implementation forms.

The solutions according to present disclosure aim to provide a generalized and systematic procedure for determining the codeword that provides the following advantages:
A unique systematic framework for all scenarios, applications, and configurations.
Codewords and codebooks can be generated on the fly based on quadric expressions.
Compressed representation of codewords and codebooks comprising a few parameters instead of thousands.
Easy and fast codeword generation from quadrics representation.
Direct codeword generation.

It has to be noted that all devices, elements, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above described aspects and implementation forms will be explained in the following description of specific embodiments in relation to the enclosed drawings, in which

FIG. 1 shows a radiofrequency device according to this disclosure;

FIG. 2 shows exemplary configurations of the scattering surface of a DCS;

FIG. 3 shows an exemplary flowchart for generating a codeword according to this disclosure;

FIG. 4 shows an example to determine the phase shift for each of the scattering elements of the DCS;

FIG. 5 shows exchanged information between the transmitter, the DCS controller and the scattering surface of the DCS;

FIG. 6 shows a radiofrequency device according to this disclosure;

FIG. 7 shows a radiofrequency device according to this disclosure;

FIG. 8 shows exchanged information between the transmitter, the DCS controller, the scattering surface of the DCS and a target or receiver;

FIGS. 9a)-d) show examples of desired electromagnetic waves scattered by one or more DCSs.

FIGS. 10a)-b) show an example of an electromagnetic wave scattered by the surface of a DCS, and an example of a desired electromagnetic wave scattered by the surface of a DCS, using the codeword, for wave focusing applications;

FIGS. 11a)-b) show an example of an electromagnetic wave scattered by the surface of a DCS, and an example of a desired electromagnetic wave scattered by the surface of a DCS, using the codeword, for plane wave generation applications;

FIGS. 12a)-c) show examples of desired electromagnetic waves scattered by two DCSs by using multiple quadric surfaces.

FIG. 13 shows a method for a radiofrequency device according to this disclosure.

### DETAILED DESCRIPTION OF EMBODIMENTS

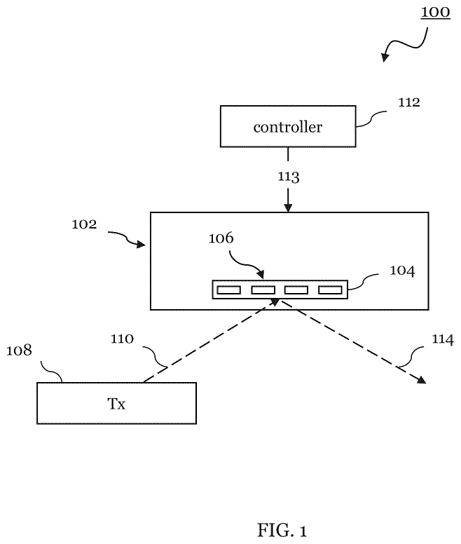

FIG. 1 shows an exemplary embodiment of a radiofrequency device 100 according to this disclosure. The device 100 comprises a DCS 102 with a scattering surface 104. The device 100 further comprises a transmitter 108 and a DCS controller 112. A position of the transmitter 108 and a position and orientation of the DCS 102 may be fixed relative to each other. The scattering surface 104 of the DCS 102 comprises a plurality of scattering elements 106. Each scattering element 106 of the scattering surface 104 has a controllable phase shift, which may be controlled by the DCS controller 112, as it will be explained below. Further, the DCS controller 112 may be implemented or may be part of the DCS 102, or may be implemented or may be part of the transmitter 108.

The transmitter 108 is configured to transmit an electromagnetic wave 110 onto the scattering surface 104 of the DCS 102.

In this disclosure, the terms wave and wavefront may be used interchangeably. Further, the terms electromagnetic signal and electromagnetic wave or wavefront may also be used interchangeably.

The DCS controller 112 is configured to determine a codeword 113 based on one or more parameters of the DCS 102, a characteristic of the electromagnetic wave 110 transmitted by the transmitter 108, and a characteristic of a desired electromagnetic wave 114 scattered by the scattering surface 104 of the DCS 102.

The codeword 113 determines a phase shift configuration for the plurality of scattering elements 106 of the scattering surface 104 of the DCS 102.

Then, the DCS controller 112 is configured to control the scattering elements 106 of the scattering surface 104 of the DCS 102, using the codeword 113, such that the desired electromagnetic wave 114 is formed by scattering the electromagnetic wave 110 transmitted by the transmitter 108, and that reaches the scattering surface 104 of the DCS 102. The desired electromagnetic wave 114 may then reach a region of interest.

In general, in this disclosure, the characteristic of the electromagnetic wave 110 transmitted by the transmitter 108, which is considered by the DCS controller 112 for determining the codeword 113 is the characteristic of the electromagnetic wave 110 as it impinges on the scattering surface 104 of the DCS 102, i.e., at the DCS 102.

That is, the characteristic of the electromagnetic wave 110 transmitted by the transmitter 108, which is used by the DCS controller 112 is as perceived by the DCS 102 upon the electromagnetic wave 110 reaching the scattering surface 104 of the DCS 102. It may not correspond to a characteristic of the same electromagnetic wave 110 at the transmitter 108, i.e., as it is generated at the transmitter 108. This is due to the fact that the electromagnetic wave 110 generated by the transmitter 108 may experience one or more changes as it propagates through a channel between the transmitter 108 and the DCS 102, for example, due to one or more physical obstacles located between the transmitter 108 and the DCS 102. Thus, the relevant characteristic of the electromagnetic wave 110 for the DCS controller 112 is the one it has when reaching the scattering surface 104 of the DCS 102.

Optionally, the DCS controller 112 of the DCS 102 can take into account the characteristic of the electromagnetic wave 110 as it is generated at the transmitter 108, for example, by determining the characteristic of the electromagnetic wave 110 at the scattering surface 104 of the DCS 102 (as it impinges onto the DCS 102) by using a determined transfer function that considers the channel for the electromagnetic wave 110 between the transmitter 108 and the DCS 102.

The characteristic of the electromagnetic wave 110 transmitted by the transmitter 108 may comprise at least one of a propagation vector and a structure of the electromagnetic wave 110 transmitted by the transmitter 108 as perceived at the scattering surface 104 of the DCS 102. For example, the propagation vector may be derived from the angle of arrival (AoA), of the electromagnetic wave 110 transmitted by the transmitter 108, at the scattering surface 104 of the DCS 102. The AoA can be alternative computed from the angle of departure (AoD) of the electromagnetic wave 110 transmitted by the transmitter 108 as it is generated at the transmitter 108 itself and other information, as for example relative positions and orientations. The structure of the electromagnetic wave 110 may comprise, for example, a plane wave or a spherical wave, which may correspond to a near field scenario or far field scenario respectively.

The characteristic of the desired electromagnetic wave 114 scattered by the scattering surface 104 of the DCS 102 may comprise at least one of a desired propagation vector and a structure of the desired electromagnetic wave 114 scattered by the scattering surface 104 of the DCS 102. For example, the desired propagation vector may be derived from the angle of departure (AoD) of the desired electromagnetic wave 114 that is obtained by scattering, with the surface 104 of the DCS 102, the electromagnetic wave 110 transmitted by the transmitter 108. The structure of the desired electromagnetic wave 114 may comprise, for example, a plane wave or a spherical wave that may correspond to a desired near field scenario or a desired far field scenario, respectively.

The one or more parameters of the DCS 102 may comprise at least one of the position of the DCS 102, an orientation of the DCS 102, a size of each of the scattering elements 106 of the scattering surface 104 of the DCS 102, and a total number of the scattering elements 106 of the scattering surface 104 of the DCS 102.

Thereby, the radiofrequency device 100 according to this disclosure may design a phase shift configuration for each of the scattering elements 106 of the DCS 102, i.e., the codeword 113, and may further use it to control the surface 104 of the DCS 102, in order to form an electromagnetic wave 114 as desired, for example for a specific application of the radio frequency device 100, by scattering the electromagnetic wave 110 transmitted by the transmitter 108.

Further advantageously, since the codeword 113 may be determined by taking into consideration the characteristics of the electromagnetic wave 110 transmitted by the transmitter, the one or more parameters of the DCS itself and the characteristics of the desired electromagnetic wave 114, the radio frequency device 100 according to this disclosure may operate in several possible scenarios, for instance in the near field or far field, and may be used in several applications, including for example beam focusing, single- and multi-user focusing or hologram generation, and may be used in different technologies.

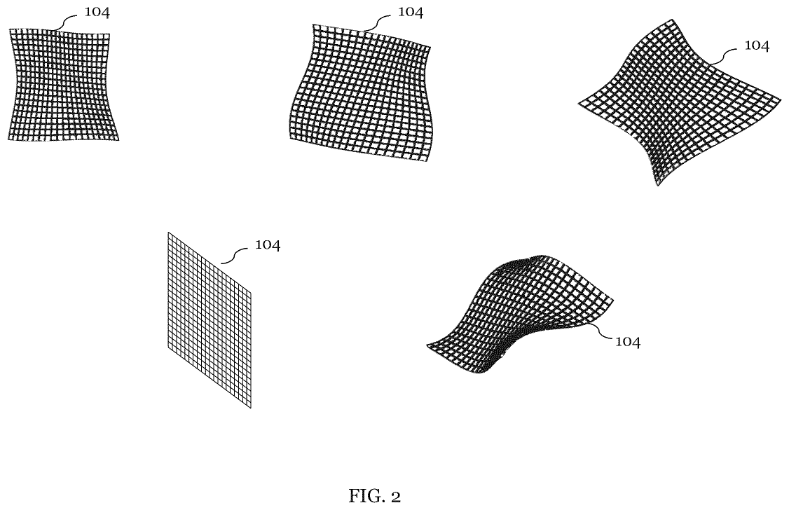

Notably, in this disclosure, the scattering surface 104 of the DCS 102 may have different configurations. For instance, as shown in FIG. 2, the scattering surface 104 of the DCS 102 may have different shapes. For example, the scattering surface 104 may be plane or non-plane.

The proposed codeword determination according to this disclosure may be based on the reflection properties of quadric surfaces. The DCS controller 112 may determine the codeword 113 by deriving an optimal quadric surface (or quadric) and its parameters. The optimal quadric may describe a transformation to be applied by the scattering surface 104 of the DCS 102 on the electromagnetic wave 110 transmitted by the transmitter, in order to obtain the desired electromagnetic wave 114, and then the behavior of the quadric reflection may be mapped to the surface 104 of the DCS 102. This mapping may consist in determining the phase shift for each of the scattering elements 106 of the surface 104 of the DCS 102, such that the desired electromagnetic wave 114 scattered by the DCS 102 is the same as if it has been reflected by a PEC or mirror having the shape of the optimal quadric surface, for example a paraboloid of revolution or another quadric shape in two-dimensions (2D) or in three dimensions (3D).

In this disclosure, it is generally considered that the optimal quadric surface Q* may describe a transformation to form the desired electromagnetic wave 114 from the electromagnetic wave 110 impinging the scattering surface 104 of the DCS 102.

That is, the DCS controller 112 may be configured to determine a quadric surface Q that is defined by the general expression of the canonical form given in Equation (1):

$${( - 1 )}^{{α}_{2}} {( \frac{x}{a} )}^{{α}_{1}} + {( - 1 )}^{{β}_{2}} {( \frac{y}{b} )}^{{β}_{1}} + {( - 1 )}^{{γ}_{2}} {( \frac{z}{c} )}^{{γ}_{1}} = {( - 1 )}^{τ} d \qquad ( 1 )$$

where a, b, c, d, α₁, α₂, β₁, β₂, γ₁, γ₂, and τ, are parameters of the quadric surface Q, with α₂, β₂, γ₂, τ∈{0,1}.

The quadric surface Q given in Equation (1) is a general representation of quadric shapes and represents a large family of functions comprising, for example, an ellipse, a parabola and a hyperbola in the 2D domain, or for example an hyperboloid, a paraboloid and an ellipsoid in 3D.

In this disclosure, the term quadric surface is used to refer to both, a conic in 2D or a quadric surface in 3D.

Then, in order to ensure that the scattering surface 104 of the DCS 102 may be capable to generate, or approximate, the desired electromagnetic wave 114 by scattering the electromagnetic wave 110, the quadric surface Q may be optimized, i.e., an optimal quadric surface Q* and its respective parameters may be obtained taking into account the characteristic of the electromagnetic wave 110 transmitted by the transmitter 108, the one or more parameters of the DCS 102 and the characteristic of the desired electromagnetic wave 114 scattered by the DCS 102.

Once the optimal quadric surface Q* and its parameters are obtained, the phase shift for each of the scattering elements 106 of the DCS 102 may be calculated to emulate the quadric behavior, e.g., to emulate a reflection as performed by the optimal quadric surface Q* that behaves as a PEC.

That is, the phase shift configuration for the plurality of scattering elements 106 of the scattering surface 104 of the DCS 102 results in a scattered wave from the DCS surface 104 that may emulate the reflection of the electromagnetic wave 110, as if it was performed by the optimal quadric surface Q*. This may correspond to a morphism between two surfaces, e.g., between the scattering surface 104 of the DCS 102 and the obtained optimal quadric surface Q*.

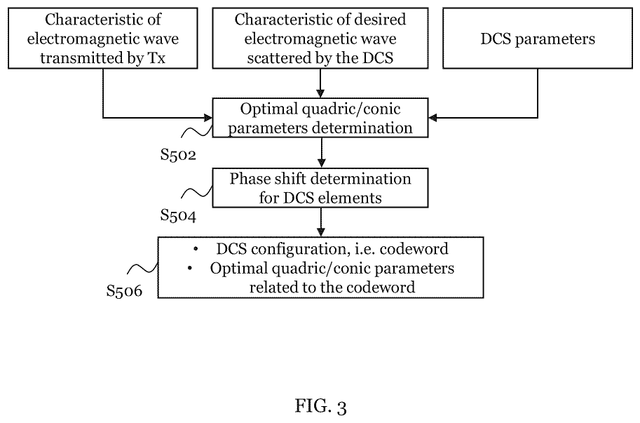

Based on the above, FIG. 3 shows a flowchart of a codeword 113 determination according to the present disclosure, which may be performed by the radio frequency device 100. In particular, it may be performed by the DCS controller 112.

The DCS controller 112 may be configured to determine the generalized quadric surface Q as defined in Equation (1).

In step S502, the DCS controller may be configured to determine the optimal quadric surface Q* that describes a transformation of the electromagnetic wave 110 transmitted by the transmitter 108 to form the desired electromagnetic wave 114 scattered by the scattering surface 104 of the DCS 102, based on the quadric surface Q (that behaves as PEC as described above), based on the characteristic of the electromagnetic wave 110 transmitted by the transmitter 108, and based on the characteristic of the desired electromagnetic wave 114 scattered by the scattering surface 104 of the DCS 102.

By determining the optimal quadric surface Q*, its respective parameters may be also determined by the DCS controller 112.

Then, in step S504, the DCS controller may be configured to determine a phase shift for each of the scattering elements 106 of the scattering surface 104 of the DCS 102 as a function of one or more parameters of the optimal quadric surface Q*. The determined phase shift for each of the scattering elements 106 of the scattering surface 104 of the DCS 102 may be referred to as the phase shift configuration for the plurality of scattering elements 106.

Thereby, the phase shift configuration for the plurality of scattering elements 106 of the scattering surface 104 of the DCS 102 as a function of one or more parameters of the optimal quadric surface Q*, i.e., the codeword, can be obtained as an output in step S506.

The codeword 113, thus, may indicate the determined phase shift for each of the scattering elements 106 of the scattering surface 104 of the DCS 102 such that controlling the scattering elements 106 of the scattering surface 104 of the DCS 102, using the codeword 113, scatters the electromagnetic wave 110 transmitted by the transmitter 108 according to a reflection of the quadric surface.

In other words, the codeword 113 may be used for the design and calibration of the scattering elements 106 of the scattering surface 104 of the DCS 102, to scatter the electromagnetic wave 110 transmitted by the transmitter 108 so that the desired electromagnetic wave 114 is formed.

The optimal quadric surface Q* may be determined, for example, by solving an optimization problem given in Equation (2):

$${Q}^{*} = arg {min}_{\{ q \}} ( d ( {S}_{\{ desired scattered wave by DCS \}} , {S}_{\{ reflected impinging wave by Q \}} ) ) \qquad ( 2 )$$

where:
S_{{desired scattered wave at DCS}} is an equiphase surface of the desired electromagnetic wave 114 at the scattering surface 104 of the DCS 102,
S_{{reflected impinging wave by Q}} is an equiphase surface of a wave obtained by reflection from the quadric surface Q of the electromagnetic wave 110 transmitted by the transmitter 108 that impinges on the virtual quadric surface Q, and
d(.,.) is a distance measure between two surfaces.

The estimation of the quadric surface Q* and of its parameters may be simplified by using quadric properties that are well known in Mathematics, such as properties of an ellipsoid, a paraboloid, an hyperboloid etc.

Predefined properties of the optimal quadric surface Q* may be stored in the DCS controller 112, in order to get a fast estimate of the optimal surface Q* and of its parameters.

Alternatively, the optimization problem for determining Q* can be solved by calculating a transformation filter F(.) given in Equation (3) and that is defined such as:

$$F ( Distrib ution of input wave structure ) = Distribution of desired output wave structure \qquad ( 3 )$$

where the input wave structure refers to a structure of the electromagnetic wave 110 transmitted by the transmitter 108 that impinges on the virtual quadric surface Q, and the output wave structure refers to the structure of the desired electromagnetic wave 114.

Solving for F amounts to estimating the parameters a, b, c, d, α₁, α₂, β₁, β₂, γ₁, γ₂, and t of the optimal quadratic function Q*, which represent geometrically the effect of the filter F.

Several mathematical tools can be used for estimating these parameters such as curve fitting through surface gradient matching, which is a technique commonly used in feature tracking in 360° video scenarios, and that is given by Equation (4):

$$\vec{∇} F ( Distribution of input wave structure ) = \vec{∇} Distribution of output wave structure \qquad ( 4 )$$

Further, Equation (4) can be expressed as a minimization problem that may optimize the quadric surface Q and that is given in Equation (5):

$$ar g {min}_{F} ( \vec{∇} F ( Distribution of input wave structure ) - \vec{∇} Distribution of output wave structure ) \qquad ( 5 )$$

As a further example, an Optimal Transport method can be used to obtain the optimal quadric surface Q*, which solves for the overall distribution density of the electromagnetic waves.

It is mentioned that in the exemplary methods disclosed above for obtaining the optimal quadric surface Q*, it has been generally considered the electromagnetic wave 110 (transmitted by the transmitter 108) as it impinges on the (virtual) quadric surface Q.

As the parameters of the optimal quadric surface Q* determine the desired transformation to be applied by the surface 104 of the DCS 102, the optimal quadric surface Q* and its respective 11 parameters may determine a compressed version of the phase shift configuration of the scattering elements 106 of the DCS 102, i.e., a compressed version of the codeword 113, that is independent of a dimension and the one or more parameters of the DCS 102, as well as of the total number of scattering elements 106 of the scattering surface 104 of the DCS 102.

Further, is to be noted that in order to obtain a unique solution for the optimal quadric surface Q*, its 11 parameters may be required. Nevertheless, a relaxed version of the optimal quadric surface Q* with 10 parameters can be also used, since a biased (or scaled) version of said optimal quadric surface Q* would have the same impact on the phase shifts of the scattering elements 106 up to a modulo factor. The relaxation may be obtained by discarding the parameter d, and provides a family of potential solutions for the optimal quadric surface Q*.

As such, the parameters of the optimal quadric surface Q* may determine a universal representation of the codeword 113 for a given scenario. For a different scenario corresponding to a different transmitted electromagnetic wave 110 and/or different desired scattered wave 114, a different optimal quadric surface Q* may be obtained that determines a different codeword for the different scenario. Different scenarios can correspond to the same or different application but have in common that the codeword is determined via the parameters of a quadric. The aggregation of a set of codewords determines a codebook, obtained for the intended application and/or for a set of intended applications.

An example of a codebook construction is shown in Table 1. Given a list of M desired transformations to be performed on the electromagnetic wave 110, a codebook of codewords 113 that achieve the desired transformations on the electromagnetic wave 110 transmitted by the transmitter 108 to form a respective desired electromagnetic wave 114 scattered by the scattering surface 104 of the DCS 102, can be indexed as in Table 1.

TABLE 1
Example of a codebook using the proposed
quadric parameter representation.

| Codeword | |
|---|---|
| index | |
| (transformation | |
| ID) | Optimal quadric parameters |
| 1 | {a₁, b₁, c₁, d₁, α_{1, 1}, α_{2, 1}, β_{1, 1}, |
| | β_{2, 1}, γ_{1, 1}, γ_{2, 1}, τ₁} |
| 2 | {a₂, b₂, c₂, d₂, α_{1, 2}, α_{2, 2}, β_{1, 2}, |
| | β_{2, 2}, γ_{1, 2}, γ_{2, 2}, τ₂} |
| . | |
| . | |
| . | |
| m | {aₘ, bₘ, cₘ, dₘ, α_{1, m}, α_{2, m}, β_{1, m}, |
| | β_{2, m}, γ_{1, m}, γ_{2, m}, τₘ} |
| . | |
| . | |
| . | |
| M | {a_{M}, b_{M}, c_{M}, d_{M}, α_{1, M}, α_{2, M}, β_{1, M}, |
| | β_{2, M}, γ_{1, M}, γ_{2, M}, τ_{M}} |

In this example, the codebook may comprise a first entry comprising a first codeword 113 may have an index 1, and the parameters of the respective optimal quadric surface Q*, for example the parameters {a₁, b₁, c₁, d₁, α_{1,1}, α_{2,1}, β_{1,1}, β_{2,1}, γ_{1,1}, γ_{2,1}, τ₁} that determine a first phase shift configuration for the scattering elements 106 of the DCS 102 that may form a first desired electromagnetic wave 114 by scattering the electromagnetic wave 110 transmitted by the transmitter. Further, the codebook may comprise a second entry comprising a second codeword 113, with an index 2, and the parameters of the respective optimal quadric surface Q*, exemplary {a₂, b₂, c₂, d₂, α_{1,2}, α_{2,2}, β_{1,2}, β_{2,2}, γ_{1,2}, γ_{2,2}, τ₂}, that determine a second phase shift configuration for the scattering elements 106 of the DCS 102 that may form a second desired electromagnetic wave 114, and so on, until M codewords 113 determining the M desired transformations to be performed on the electromagnetic wave 110 are comprised in the codebook.

Moreover, since the codewords 113 may be specified as a function of the parameters of the respective optimal quadric surface Q*, each of the M codewords 113 of Table 1 may be tailored for a different type of application of the radio frequency device 100.

Thereby, the codeword 113 determination according to this disclosure based on a quadric model for the scattering surface 104 of the DCS 102 may provide not only a cheap feedback mechanism for the configuration of a DCS 102 located at known position in space for a specific application, but also a great versatility as it can easily be adapted to any DCS 102 provided that its one or more parameters are known.

The DCS controller 112 may be further configured to determine the phase shift for each of the scattering elements 106 of the scattering surface 104 of the DCS 102 based on a minimum distance between the optimal quadric surface Q* and the scattering surface 104 of the DCS 102.

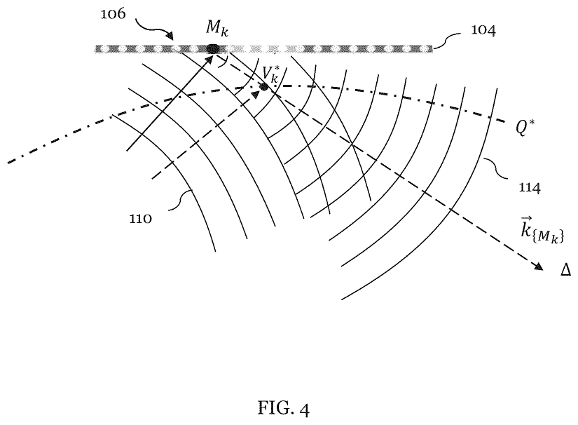

FIG. 4 depicts an exemplary determination of the phase shift for each of the plurality of scattering elements 106 of the scattering surface 104 of the DCS 102 according to this disclosure. In FIG. 4, a representation of the radio frequency device 100 is shown, which is obtained on a cutting plane including propagation vectors of the electromagnetic wave 110 transmitted by the transmitter 108 and a propagation vector of the desired electromagnetic wave 114 scattered by the scattering surface 104 of the DCS 102 and a given point Mₖ representing a scattering element of the scattering surface 104 of the DCS 102. In this example, it is considered that the optimal quadric surface Q* is uniquely defined and is tangent to the scattering surface 104 of the DCS 102.

Upon determining the unique optimal quadric surface Q*, the phase shift for each of the scattering elements 106 Mₖ can be calculated as a compensation of the quadric surface Q* and a surface spanned by the scattering elements 106 downsampled to its respective position in the actual scattering surface 104 of the DCS 102.

In this method, a distance may be interpreted as a phase based on the optimal quadric surface Q* up to a scaling factor and based on a propagation constant of the electromagnetic wave 110 transmitted by the transmitter 108 and of the desired electromagnetic wave 114.

In general, the phase shift for the k-th scattering element 106 of the DCS 102 that is located at a point Mₖ of the scattering surface 104 of the DCS 102 may be determined by Equation (6):

$${ϕ}_{\{ DCS \}}^{{M}_{k}} = {ϕ}_{\{ scattered wave from {M}_{k} \}}^{{V}_{k}^{*}} - {ϕ}_{\{ desired scattered wave \}}^{{V}_{k}^{*}} \qquad ( 6 )$$

$$where$$

$${V}_{k}^{*} = {arg min}_{{V}_{k} ∈ Δ ( {M}_{k} , {\vec{k}}_{\{ {M}_{k} \}} ) ⋂ {Q}^{*}} \{ ‖ \vec{{V}_{k} {M}_{k}} ‖ \} \qquad ( 7 )$$

and where
ϕ_{{scattered wave from M}_{ₖ}_{}}^{V}^{ₖ}^{^{*}} is the phase at V*ₖ of the electromagnetic wave that is scattered from the scattering element located at the point Mₖ after the electromagnetic wave 110 transmitted by the transmitter 108 impinges onto the DCS 102 and is scattered from the point Mₖ,
ϕ_{{desired scattered wave}}^{V}^{ₖ}^{^{*}} is the phase at V*ₖ of the desired scattered electromagnetic wave 114,
\vec{k} is a desired propagation vector of the desired electromagnetic wave 114,
\vec{k}_{{M}_{ₖ}_{}} is a propagation vector of the desired electromagnetic wave 114 observed at the point Mₖ,
Δ(Mₖ, \vec{k}_{{M}_{ₖ}_{}}) is a line passing through the point of interest Mₖ on the scattering surface 104 of the DCS 102 with a direction determined by the propagation vector \vec{k}_{{M}_{ₖ}_{}},
Δ(Mₖ, \vec{k}_{{M}_{ₖ}_{}})∩Q* represents a set of points generated by intersecting the optimal quadric surface Q* and the line Δ(Mₖ, \vec{k}_{{M}_{ₖ}_{}}).
V*ₖ is a point on the quadric surface Q* closest to the scattering surface 104 of the DCS 102 that fulfills the wave structure of the desired electromagnetic wave 114 and that is in the set Δ(Mₖ, \vec{k}_{{M}_{ₖ}_{}})∩Q*.

The example described above and depicted in FIG. 4 may correspond to a morphism computation for multi-point phase determination, which is a morphism between two surfaces in 3D, e.g., between the scattering surface 104 of the DCS 102 and the optimal quadric surface Q*.

Further, the exemplary determination of the phase shift for each of the scattering elements 106 of the DCS 102 may be implemented in several ways, for example, by using a ray construction method, or by using difference of path computation, or the like.

The DCS controller 112 may comprise a processor or processing circuitry (not shown) configured to perform, conduct or initiate the various operations of the DCS controller 112 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGA s), digital signal processors (DSPs), or multi-purpose processors. The DCS controller 112 may further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the DCS controller 112 to be performed.

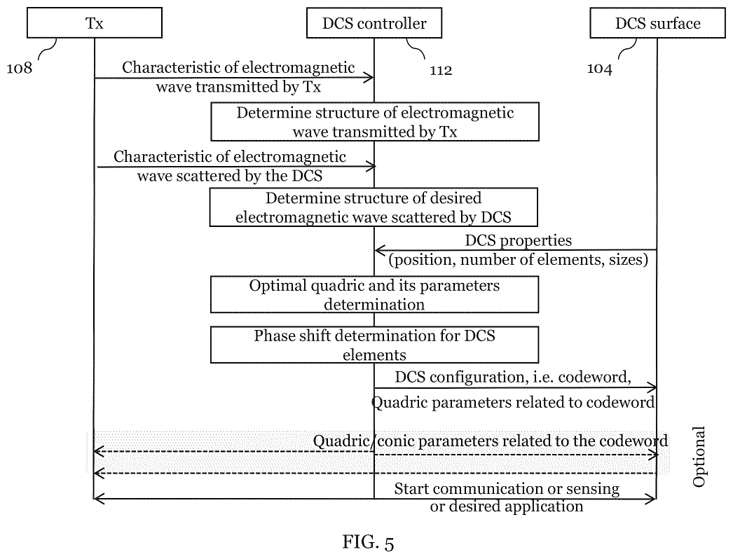

FIG. 5 shows an example of exchanged signaling in the radio frequency device 100 of FIG. 1. In particular, the example of FIG. 5 may depict a scenario where the radio frequency device 100 comprises the transmitter 108, the DCS controller 112, and the DCS 102 comprising the scattering surface 104 and the plurality of scattering elements 106. These entities can be collocated.

The DCS controller 112 may be configured to determine the characteristic of the electromagnetic wave 110 transmitted by the transmitter 108, or may be configured to obtain the characteristic of the electromagnetic wave 110 transmitted by the transmitter 108 by signaling from the transmitter 108.

Further, the DCS controller 112 may be configured to determine the characteristic of the desired electromagnetic wave 114 scattered by the scattering surface 104 of the DCS 102, or to obtain the characteristic of the desired electromagnetic wave 114 scattered by the scattering surface 104 of the DCS 102 by signaling from the transmitter 108.

The characteristic of the desired electromagnetic wave 114 may alternatively be predefined in the DCS controller 112, since it depends on an intended application of the radio frequency device 100, or can be determined through prior estimations at the transmitter 108

Thereby, the transmitter 108 may provide directly or indirectly to the DCS controller 112 the propagation vector and/or the structure of its transmitted electromagnetic wave 110. In addition, the transmitter 108 may also provide directly or indirectly to the DCS controller 112 the desired propagation vector and/or the structure of the desired electromagnetic wave 114.

Further, the DCS controller 112 may be configured to obtain the one or more parameters of the DCS 102 by signaling from the scattering surface 104 of the DCS 102 or from the DCS itself. Alternatively, the one or more parameters of the DCS 102 may be predefined in DCS controller 112.

Then, the DCS controller 112 may determine the codeword 113. In order to determine the codeword 113, the DCS controller may be further configured to determine, based on a quadric surface Q that behaves as a PEC, based on the characteristic of the electromagnetic wave 110 transmitted by the transmitter 108 and based on the characteristic of the desired electromagnetic wave 114 scattered by the scattering surface 104 of the DCS 102, an optimal quadric surface Q* that describes a transformation of the electromagnetic wave 110 transmitted by the transmitter 108 to form the desired electromagnetic wave 114 scattered by the scattering surface 104 of the DCS 102. Further, the DCS controller may be configured to determine a phase shift for each of the scattering elements 106 of the scattering surface 104 of the DCS 102 as a function of one or more parameters of the optimal quadric surface Q*.

The DCs controller 112 may then control the configuration of the scattering surface 104 of the DCS 102 by using the determined codeword 113 through a configuration signal sent by signaling from the DCS controller 112 to the scattering surface 104 of the DCS 102. That is, the DCS controller may be configured to control the scattering elements 106 of the scattering surface 104 of the DCS 102, using the codeword 113, by signaling the codeword 113 to the scattering surface 104.

The DCS controller 112 may be further configured to send the codeword 113, by signaling, to the transmitter 108.

Once the codeword 113 has been determined, the transmitter 108 may be configured to start transmitting the electromagnetic wave 110 onto the scattering surface 104 of the DCS 102.

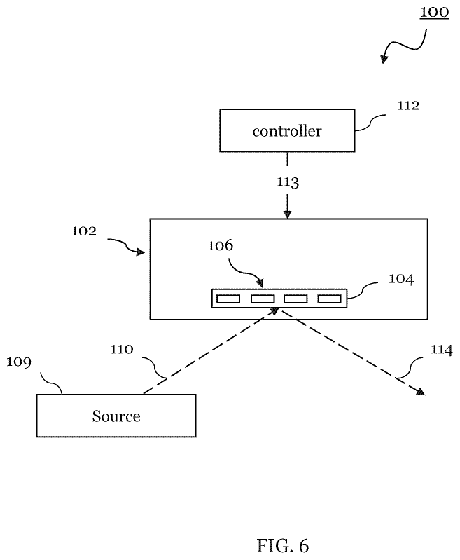

FIG. 6 shows an exemplary embodiment of the radio frequency device 100, which builds on the radio frequency device 100 shown in FIG. 1. Same elements are labelled with the same reference signs.

In the radio frequency device 100 of FIG. 6, the transmitter 108 may be a source of electromagnetic waves. That is, the radio frequency device 100 may comprise a source 109 configured to send an electromagnetic wave 110 onto the scattering surface 104 of the DCS 102. The source 109 can be a natural source, or can be any other type of source of electromagnetic waves.

Accordingly, a DCS controller 112 may be configured to determine the codeword 113 based on one or more parameters of the DCS 102, a characteristic of the electromagnetic wave 110 sent by the source 109, and the characteristic of a desired electromagnetic wave 114 scattered by the scattering surface 104 of the DCS 102. The codeword 113 determines a phase shift configuration for the plurality of scattering elements 106 of the scattering surface 104 of the DCS 102. Then, the DCS controller 112 may be further configured to control the scattering elements 106 of the scattering surface 104 of the DCS 102, using the codeword 113, to form the desired electromagnetic wave 114 by scattering the electromagnetic wave 110 sent by the source 109.

In this exemplary embodiment, the characteristic of the electromagnetic wave 110 sent by the source 109, which is taken into account by the DCS controller 112 to determine codeword 113, means the characteristic of the electromagnetic wave 110 as it impinges on the scattering surface 104 of the DCS 102.

This characteristic of the electromagnetic wave 110 (sent by the source 109) that is perceived by the DCS 102 upon the electromagnetic wave 110 reaching the scattering surface 104, may not correspond to a characteristic of the electromagnetic wave 110 as it is generated at the source 109. This is due to the fact that the electromagnetic wave 110 sent by the source 109 may experience one or more changes as it propagates through a channel between the source 109 and the DCS 102, for example, due to one or more physical obstacles located between the source 109 and the DCS 102.

Optionally, the DCS controller 112 can take into account the characteristic of the electromagnetic wave 110 as it is generated at the source 109, for example, the DCS controller 112 could determine the characteristic of the electromagnetic wave 110 at the scattering surface 104 of the DCS 102 by using a transfer function that may consider the channel for the electromagnetic wave 110 between the source 109 and the DCS 102.

The characteristic of the electromagnetic wave 110 sent by the source 109 may comprise at least one of a propagation vector and a structure of the electromagnetic wave 110 sent by the source 109 as perceived at the scattering surface 104 of the DCS 102.

The characteristic of the desired electromagnetic wave 114 scattered by the scattering surface 104 of the DCS 102 may comprise at least one of a desired propagation vector and a structure of the desired electromagnetic wave 114 scattered by the scattering surface 104 of the DCS 102, and the one or more parameters of the DCS 102 may comprise at least one of a position of the DCS 102, an orientation of the DCS 102, a size of each of the scattering elements 106 of the scattering surface 104 of the DCS 102, and a total number of the scattering elements 106 of the scattering surface 104 of the DCS 102.

The DCS controller 112 may be further configured to determine the characteristic of the electromagnetic wave 110 sent by the source 109. Additionally or alternatively, the DCS 102 controller 112 may be further configured to determine the characteristic of the desired electromagnetic wave 114 scattered by the scattering surface 104 of the DCS 102.

A position of the source 109 and a position and orientation of the DCS 102 may be fixed relative to each other.

The DCS controller 112 may be further configured to determine, based on a quadric surface Q that behaves as a perfect electric conductor, PEC, based on the characteristic of the electromagnetic wave 110 sent by the source 109, and based on the characteristic of the desired electromagnetic wave 114 scattered by the scattering surface 104 of the DCS 102, an optimal quadric surface Q* that describes a transformation of the electromagnetic wave 110 sent by the source 109, to form the desired electromagnetic wave 114 scattered by the scattering surface 104 of the DCS 102. Then, the DCS controller 112 may be configured to determine a phase shift for each of the scattering elements 106 of the scattering surface 104 of the DCS 102 as a function of one or more parameters of the optimal quadric surface Q*.

In this exemplary embodiment, the optimal quadric surface Q* may describe a transformation to form the desired electromagnetic wave 114 from the electromagnetic wave 110 impinging on the scattering surface 104 of the DCS 102.

The quadric surface Q has the canonical equation and corresponding parameters given in Equation (1).

The DCS controller 112 may be further configured to determine the phase shift for each of the scattering elements 106 of the scattering surface 104 of the DCS 102 based on a minimum distance between the optimal quadric surface Q* and the scattering surface 104 of the DCS 102.

The codeword 113 may indicate the determined phase shift for each of the scattering elements 106 of the scattering surface 104 of the DCS 102 such that controlling the scattering elements 106 of the scattering surface 104 of the DCS 102, using the codeword 113, scatters the electromagnetic wave 110 sent by the source 109 according to a reflection of the quadric surface.

The exemplary methods for obtaining the optimal quadric surface Q* and the phase shift for each of the plurality of scattering elements 106 of the scattering surface 104 of the DCS 102 disclosed above for the exemplary embodiment of FIG. 1, can be equivalently used for the exemplary embodiment of FIG. 6 by taking into account the electromagnetic wave 110 sent by the source 109 as it impinges on the quadric surface Q, additionally or alternatively as it impinges on the scattering surface 104 of the DCS 102.

In another exemplary embodiment, the radio frequency device 100 according to this disclosure may neither comprise the transmitter 108 nor the source 109. That is, the radio frequency device 100 may comprise the DCS 102 comprising a scattering surface 104 that comprises a plurality of scattering elements 106, each having a controllable phase shift, and the DCS controller 112.

The DCS controller 112 may be configured to determine a codeword 113 based on one or more parameters of the DCS 102, a characteristic of an electromagnetic wave 110 impinging onto the scattering surface 106 of the DCS, and a characteristic of a desired electromagnetic wave 114 scattered by the scattering surface 104 of the DCS 102. The codeword 113 may determine a phase shift configuration for the plurality of scattering elements 106 of the scattering surface 104 of the DCS 102. Further, the DCS controller 112 may be configured to control the scattering elements 106 of the scattering surface 104 of the DCS 102, using the codeword 113, to form the desired electromagnetic wave 114 by scattering the electromagnetic wave 110 impinging onto the scattering surface 104 of the DCS 102.

The electromagnetic wave 110 impinging onto the scattering surface 104 of the DCS 102 can be generated, for example, but not limited to, by any kind of unknown source or transmitter or the like.

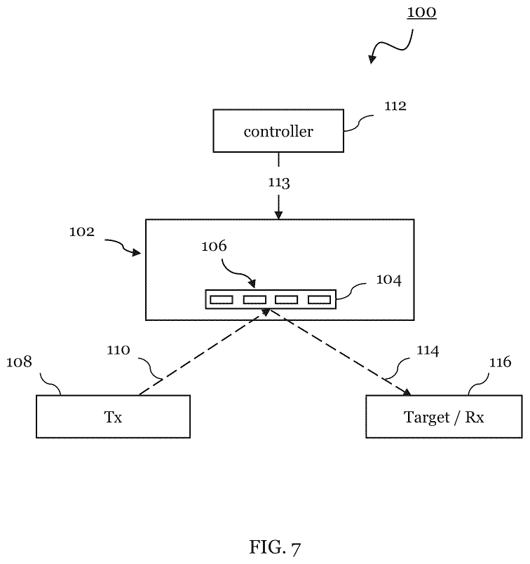

FIG. 7 shows an exemplary embodiment of a radio frequency device 100 according to this disclosure, which builds on the radio frequency device 100 shown in FIG. 1. Same elements are labelled with the same reference signs.

The radio frequency device 100 of FIG. 7 further comprises a target 116 that is illuminated by the desired electromagnetic wave 114 scattered by the scattering surface 104 of the DCS 102. In particular, the target may be a receiver 116 configured to receive the desired electromagnetic wave 114 scattered by the scattering surface 104 of the DCS 102.

The DCS controller 112 may be implemented or may be part of the DCS 102. Alternatively, the DCS controller 112 may be implemented or may be part of the transmitter 108. Further alternatively, the DCS controller 112 may be implemented or may be part of the target/receiver 116.

Then, the DCS controller 112 is configured to determine the codeword 113 based on the one or more parameters of the DCS 102, the characteristic of the electromagnetic wave 110 transmitted by the transmitter 108, and the characteristic of a desired electromagnetic wave 114 scattered by the scattering surface 104 of the DCS 102.

Further, the DCS controller 112 is configured to control the scattering elements 106 of the scattering surface 104 of the DCS 102, using the codeword 113, to form the desired electromagnetic wave 114 by scattering the electromagnetic wave 110 transmitted by the transmitter 108.

The DCS controller 112 is further configured to obtain the characteristic of the desired electromagnetic wave 114 scattered by the scattering surface 104 of the DCS 102 by using information about the target/receiver 116. Alternatively, the DCS controller may obtain the characteristic of the desired electromagnetic wave 114 scattered by the scattering surface 104 of the DCS 102 by signaling from the target/receiver 116.

In the radio frequency device 100 of FIG. 7, the transmitter 108 may be a source of electromagnetic waves, the source being configured to send the electromagnetic wave 110 onto the scattering surface 104 of the DCS 102, as disclosed in the example of FIG. 6. The source can be a natural source, or can be any other type of source of electromagnetic waves.

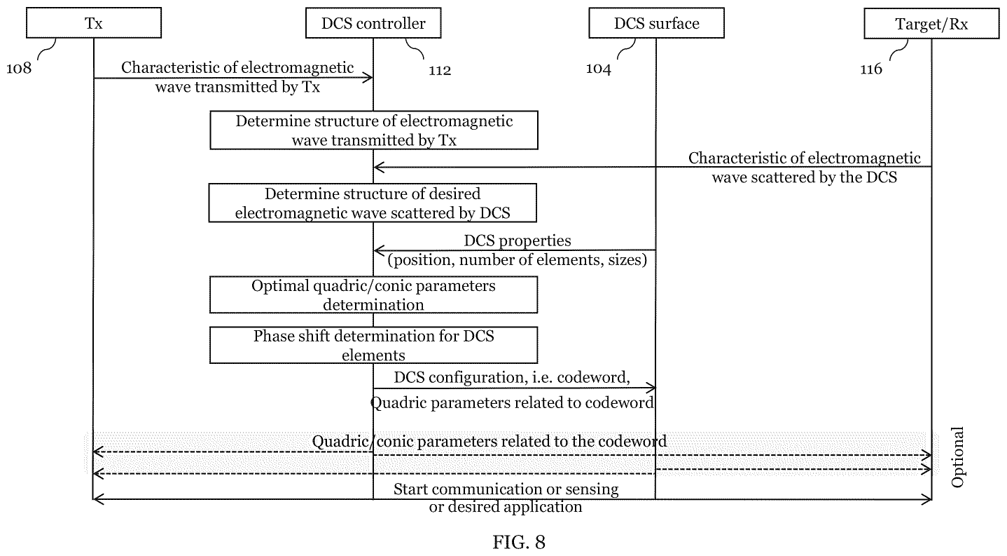

FIG. 8 shows an example of exchanged signaling in the radio frequency device 100 of FIG. 7. The example of FIG. 8 may depict a scenario where the radio frequency device 100 comprises the transmitter 108, the DCS controller 112, the DCS 102 comprising the scattering surface 104, and the target or receiver 116. These entities can be collocated.

The example of FIG. 8 is the same as the one shown in FIG. 5, except that in FIG. 8 the DCS controller 112 may obtain the characteristic of the desired electromagnetic wave 114 scattered by the scattering surface 104 of the DCS 102 by signaling from the target/receiver 116. Alternatively, the DCS controller 112 may obtain the characteristic of the desired electromagnetic wave 114 scattered by the scattering surface 104 of the DCS 102 by using information about the target/receiver 116. Further, the characteristic of the desired electromagnetic wave 114 may alternatively be determined through prior estimations at the target or by application of reciprocity in case that a reverse path communication between the transmitter 108 and the receiver 116 may be possible.

Based on the properties of the quadric surface Q, the radio frequency device 100 according to this disclosure may be used for several applications. Further, the mathematical properties of the generalized quadric surface Q given in Equation (1) may be used in order to reduce the number of parameters of the quadric Q employed to determine the codeword 113, thereby reducing complexity on the determination of the optimal quadric surface Q* and its parameters as well as of the phase shift of the scattering elements 106 of the DCS 102.

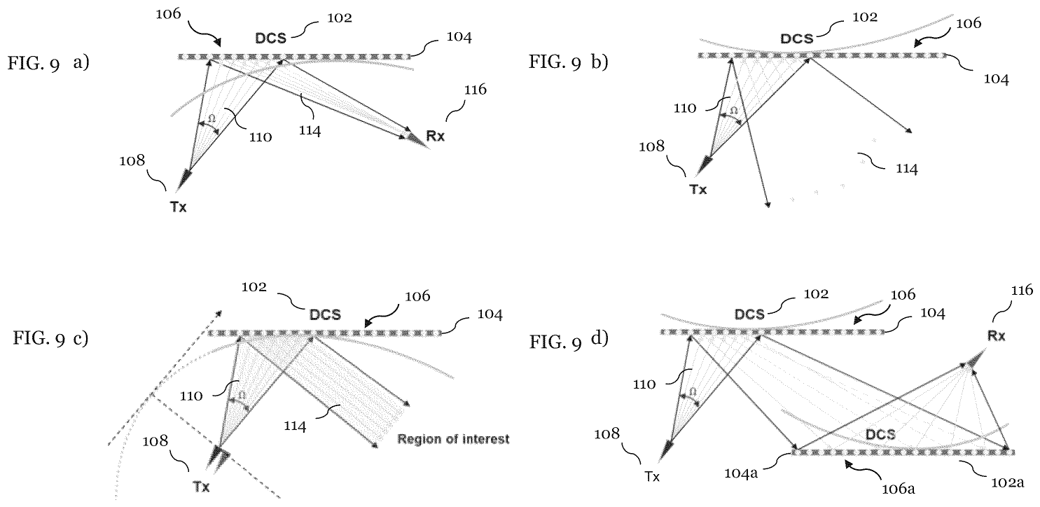

Exemplary applications of the radio frequency device 100 are shown in FIGS. 9a) to 9d), where the DCS controller 112 is not depicted for the sake of clarity. The exemplary applications may comprise ray focusing, see FIG. 9a), ray diffracting, see FIG. 9b), ray parallelization (plane wave generation), in FIG. 9c), and enhancement of an antenna aperture based on a combination of more than one DCS, exemplary DCS 102 and 102a, see FIG. 9d).

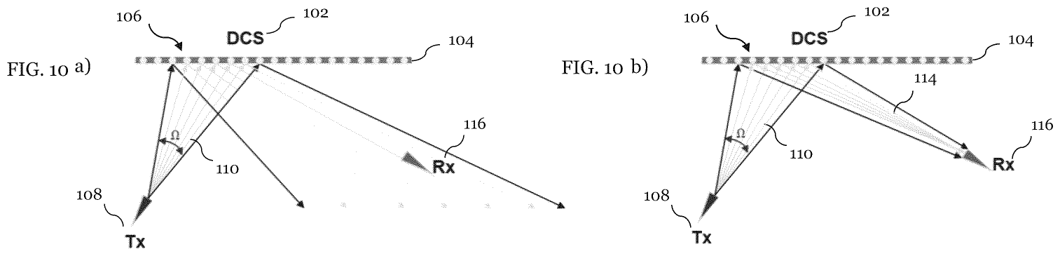

FIG. 10b) depicts an exemplary use of the radio frequency device 100 of FIG. 7 for wave focusing, where the DCS controller 112 is not shown for the sake of clarity.

In the example of FIG. 10b), the target 116 may be in particular the receiver 116, and a position of the transmitter 108 and a position of the receiver 116 are fixed relative to each other. The DCS controller 112 may be configured to determine the codeword 113 of the DCS 102 in order to maximize the energy received at the position of the receiver 116, that is, to focus the electromagnetic wave 110 transmitted by the transmitter 108 onto the receiver 116 via the DCS 102.

FIG. 10a) depicts an electromagnetic wave scattered by the scattering surface 104 of the DCS 102 that may be obtained in a natural propagation and reflecting scenario, i.e., without using the codeword 113, which follows the Snell-Descartes law for an antenna aperture Ω of the transmitter 108, and which may not be focused onto the receiver 116 as desired.

Then, the DCS controller 112 may determine the codeword 113 based on the one or more parameters of the DCS 102, the characteristic of the electromagnetic wave 110 transmitted by the transmitter 108, and the characteristic of the desired electromagnetic wave 114 scattered by the scattering surface 104 of the DCS 102. Then, the DCS controller may control the scattering elements 106 of the scattering surface 104 of the DCS 102, using the codeword 113, to form the desired electromagnetic wave 114, i.e., an electromagnetic wave that is focused onto the receiver 116, by scattering the electromagnetic wave 110 transmitted by the transmitter 108. This is depicted in FIG. 10b).

In this exemplary application, the structure of the electromagnetic wave 110 transmitted by the transmitter 108 may be a cylindrical cone with numerical aperture of 22. The structure of the electromagnetic wave 110 can be obtained by the DCS controller 112 from the position of the transmitter 108 and its antenna aperture.

The structure of the desired electromagnetic wave 114 scattered by the DCS 102 may comprise a wavefront that should be focusing inphase on a specific point in space on the receiver 116. Thus, the desired characteristic of the desired electromagnetic wave 114 scattered by the DCS 102, i.e., the desired focusing of the electromagnetic wave 110 onto the receiver 116, may be obtained by the DCS controller 112 by signaling from the receiver 116. Alternatively, the DCS controller 112 may obtain the characteristic of the desired electromagnetic wave 114 by using information about the receiver 116, for example the position of the receiver 116.

Further, the one or more parameters of the DCS 102 may comprise at least one of the position of the DCS 102, the size of each of the scattering elements 106 of the scattering surface 104 of the DCS 102, and the total number of the scattering elements 106 of the scattering surface 104 of the DCS 102.

In order to determine the codeword 113, the DCS controller 112 may determine the optimal quadric surface Q* that describes a transformation of the electromagnetic wave 110 transmitted by the transmitter 108 to form the desired (focusing) electromagnetic wave 114 scattered by the DCS 102 based on: the quadric surface Q that behaves as a PEC, the characteristic of the electromagnetic wave 110 transmitted by the transmitter 108 and the characteristic of the desired electromagnetic wave 114 scattered by the scattering surface 104 of the DCS 102.

In the exemplary application of FIG. 10b), the DCS controller may determine a quadric surface Q with two focal points that is obtained through an ellipsoid of revolution or spheroid with foci points Tx (transmitter 108) and Rx (receiver 116) and that is tangent to the DCS 102. Such an ellipsoid of revolution is obtained from the generalized canonical equation for the quadric surface Q, Equation (1), with the parameters values α₁=β₁=γ₁=2, @₂=β₂=γ₂=τ=0, d=1, and b=c, given in its canonical form by Equation (8)

$$\frac{{x}^{2}}{{a}^{2}} + \frac{{y}^{2} + {z}^{2}}{{b}^{2}} = 1 \qquad ( 8 )$$

The ellipsoid of revolution (8) may be further optimized by the DCS controller 112 based on the characteristic of the electromagnetic wave 110 transmitted by the transmitter 108 and based on the characteristic of the desired electromagnetic wave 114 scattered by the scattering surface 104 of the DCS 102, resulting in the optimal quadric surface Q* with its corresponding parameters.

The DCS controller 112 may determine the optimal quadric surface Q* by using, for example, an analytical method that solves a gradient of a desired quadric surface that yields the desired electromagnetic wave 114, and by further fitting it with a gradient of the canonical expression of the quadric surface Q given in Equation (1).

As a further example, the DCS controller 112 may determine the optimal quadric surface Q* by using a geometrical construction method, which takes into account the quadric properties that are well known in mathematics, such as the properties of an ellipsoid, a paraboloid, or a hyperboloid, based on the characteristic of the electromagnetic wave 110, the one or more parameters of the DCS 102, and the desired application.

Then, the DCS controller 112 may determine the phase shift for each of the scattering elements 106 of the scattering surface 104 of the DCS 102 as a function of the one or more parameters of the optimal quadric surface Q*, based on the minimum distance between the optimal quadric surface Q* and the scattering surface 104 of the DCS 102.

In this example, the generalized equation for the phase shift for the k-th scattering element 106 of the DCS 102 given by Equation (6) can be written as Equation (9)

$${ϕ}_{\{ D C S \}}^{{M}_{k}} = {Φ}_{T x}^{{M}_{k}} + {Φ}_{{M}_{k}}^{R x} - {Φ}_{T x}^{{V}_{k}^{*}} - {Φ}_{{V}_{k}^{*}}^{R x} \qquad ( 9 )$$

where Φ_{Tx}^{Mk} is a phase of the electromagnetic wave 110 transmitted by the transmitter 108 from the point Tx and observed at a point Mₖ on the scattering surface 104 of the DCS 102, Φ_{M}_{ₖ}^{Rx} is a phase of the desired electromagnetics wave 114 scattered from the point Mₖ and that is received at the point Rx of the receiver 116, Φ_{Tx}^{V*}^{ₖ} is a phase of the electromagnetic wave 110 transmitted by the transmitter 108 from the point Tx and observed at a point V*ₖ on the optimal quadric surface Q*, and Φ_{V*}_{ₖ}^{Rx} is a phase of an electromagnetic wave reflected from V*ₖ and that is received at the point Rx of the receiver 116.

The phase shift of the k-th scattering element 106 of the DCS 102 that meets the focusing requirement and that behave as the optimal ellipsoid of revolution surface Q*, may be obtained as

$${ϕ}_{\{ D C S \}}^{{M}_{k}} = \frac{2 π}{λ} ( ‖ \vec{T x {M}_{k}} ‖ + ‖ \vec{{M}_{k} R x} ‖ - 2 a ) \qquad ( 10 )$$

where a is a parameter of the optimal quadric surface Q*, Mₖ specifies the position of the k-th scattering element 106 of the DCS 102, \vec{AB} represents a vector between the two points A and B, and ∥.∥ is the Euclidian norm operator.

Further, the DCS controller 112 may control the scattering elements 106 of the scattering surface 104 of the DCS 102, using the codeword 113, to form the desired electromagnetic wave 114 by scattering the electromagnetic wave 110 transmitted by the transmitter 108, and that achieves the exemplary application of FIG. 10b).

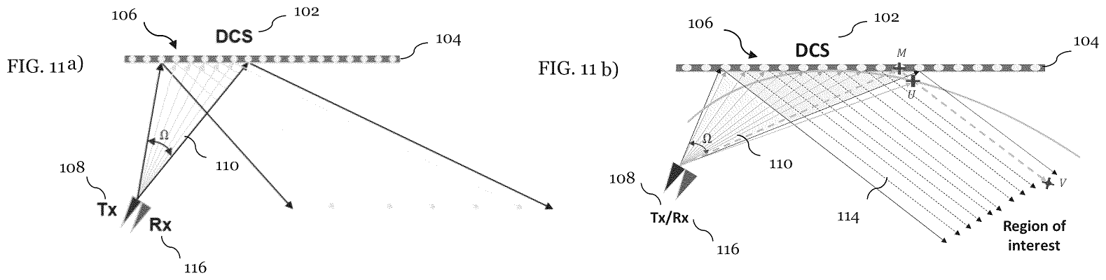

FIG. 11b) shows another exemplary use of the radio frequency device 100 of FIG. 1 or FIG. 7 for plane wave generation purposes. In other words, the example in FIG. 11b) aims to parallelize the rays of the electromagnetic wave 114 scattered by the DCS 102. In contrast, FIG. 11a) shows an exemplary electromagnetic wave scattered by the DCS 102 with a non-optimized scattering surface 104 of the DCS 102, i.e., without using the codeword 113. In the examples of FIGS. 11a) and 11b), the DCS controller 112 is not shown for the sake of clarity.

In FIG. 11b), the position of the surface 104 of the DCS 102 may be known and may be fixed relative to the transmitter 108. In addition, the one or more parameters of the DCS 102 may comprise at least one of a position of the DCS 102, an orientation of the DCS 102, a size of each of the scattering elements 106 of the scattering surface 104 of the DCS 102, and a total number of the scattering elements 106 of the scattering surface 104 of the DCS, may be pre-set or predefined in the DCS controller 112.

In this exemplary application, the structure of the electromagnetic wave 110 transmitted by the transmitter 108 may be a spherical wave or plane wave confined in a cylindrical cone with numerical aperture of Ω. The structure of the electromagnetic wave 110 can be obtained by the DCS controller 112 from the position of the transmitter 108 and its antenna aperture.

The structure of the desired electromagnetic wave 114 scattered by the DCS 102 may comprise equiphase plane waves perpendicular to a direction of propagation as well as parallel rays that may be required in order to illuminate, with the desired electromagnetic wave 114, a target that may be place on the region of interest. The desired characteristic of the desired electromagnetic wave 114 scattered by the DCS 102, may be obtained by the DCS controller 112 by signaling from the transmitter 108. Alternatively, the DCS controller 112 may obtain the characteristic of the desired electromagnetic wave 114 by using information about the region of interest, for example its position with respect to the position of the DCS 102 and/or with respect to the position of the transmitter 108.

Further, the one or more parameters of the DCS 102 may comprise at least one of the position of the DCS 102, the size of each of the scattering elements 106 of the scattering surface 104 of the DCS 102, and the total number of the scattering elements 106 of the scattering surface 104 of the DCS 102.

Given a position of a transmitter antenna 108 with a fixed antenna aperture Ω, a quadric surface Q that allows obtaining the desired electromagnetic plane wave 114 scattered by the DCS 102 onto a region of interest may be a paraboloid of revolution.

Such an optimal paraboloid of revolution Q* may be obtained from the generalized canonical form of the quadrics, Equation (1), with the parameters values α₁=β₁=2, γ₁=γ₂=c=1, α₂=β₂=d=t=0, and a=b=\sqrt{2p}, and is represented in its canonical form in Equation (11),

$$\frac{{x}^{2} + {y}^{2}}{2 p} - z = 0 ⇒ {x}^{2} + {y}^{2} = 2 p z \qquad ( 11 )$$

where p is a minimum distance of focal point of the paraboloid to its directory.

For unicity, an elliptic paraboloid with focal points TX/RX (transmitter 108/receiver 116), shown in FIG. 11b), and that is tangent to the DCS 102 is considered, so that p is fixed.

Then, the DCS controller 112 may optimize the paraboloid of revolution given by (10) based on the characteristic of the electromagnetic wave 110 transmitted by the transmitter 108 and based on the characteristic of the desired electromagnetic wave 114 scattered by the scattering surface 104 of the DCS 102, resulting in the optimal quadric surface Q* and its corresponding parameters.

Further, the DCS controller 112 may determine the phase shift for each of the scattering elements 106 of the scattering surface 104 of the DCS 102 as a function of the one or more parameters of the optimal quadric surface Q*.

In this example, the generalized equation for the phase shift for the k-th scattering element 106 of the DCS 102 given by Equation (6) can be written, for the optimal paraboloid surface Q*, by Equation (12)

$${ϕ}_{\{ D C S \}}^{{M}_{k}} = \frac{2 π}{λ} ( ‖ \vec{T x {M}_{k}} ‖ + ‖ \vec{{M}_{k} V} ‖ - ‖ \vec{T x U} ‖ - ‖ \vec{UV} ‖ ) \qquad ( 12 )$$

where U and V are points that belong to the optimal paraboloid surface Q* and to the region of interest, respectively, Mₖ specifies the position of the k-th scattering element 106 on the scattering surface 104 of the DCS 102, \vec{AB} represents a vector between the two points A and B, and ∥.∥ is the Euclidian norm operator.

Then, the DCS controller 112 may control the scattering elements 106 of the scattering surface 104 of the DCS 102, using the codeword 113, to form the desired electromagnetic wave 114 by scattering the electromagnetic wave 110 transmitted by the transmitter 108, and that achieves the exemplary application of FIG. 11b).

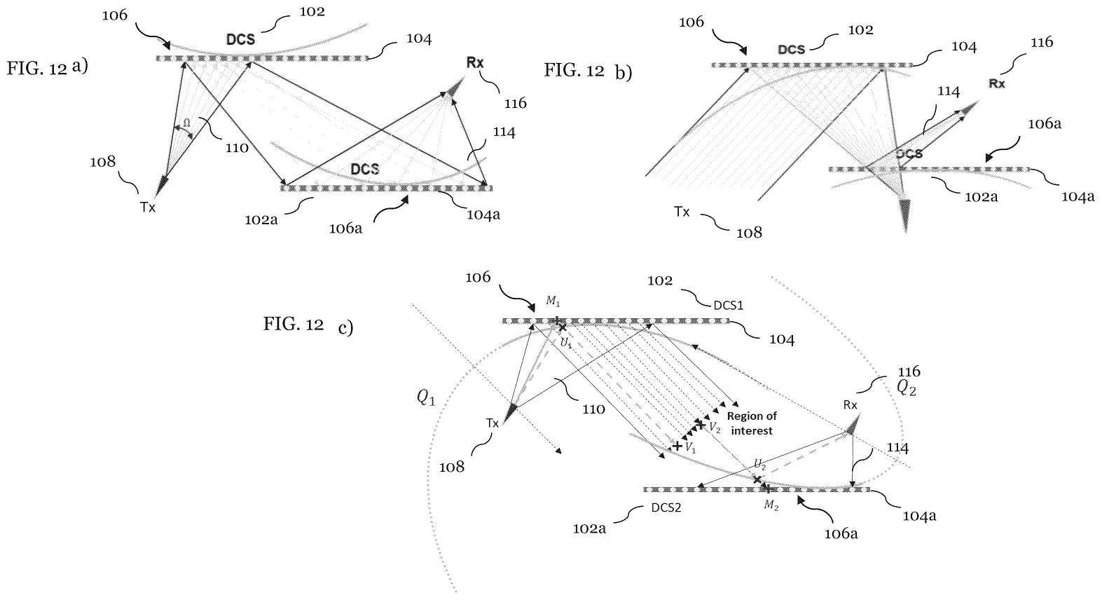

FIGS. 12a) to 12c) show further exemplary uses of the radio frequency device 100 in which more than one quadric surfaces Q are used in order to generate the codeword 113. The example of FIG. 12a) may be applied in antenna enhancement, since it may virtually increase an antenna aperture. The example of FIG. 12b) may be applied in multi-source focusing at the position of the receiver 116. The example of FIG. 12c) may be applied in antenna enhancement for hologram generation in a bistatic mode.

In the examples of FIGS. 12a) to 12c), the radio frequency device 100 builds on the radio frequency device 100 of FIG. 7 and may further comprise an additional DCSs 102a comprising a scattering surface 104a that comprises a plurality of scattering elements 106a. In FIGS. 12a) to 12c), the DCS controller 112 is not shown for the sake of clarity.

In the examples depicted in FIGS. 12a) to 12c), the one or more DCS 102, 102a may be used in a propagating environment and may be combined to achieve a specific desired propagation effect.

In order to generate the codeword 113, the DCS controller may combine multiple quadratic surfaces Q or may split a quadratic surface Q into multiple quadratic surface. This may make the design and estimation of the desired electromagnetic wave 114 easier and, notably, more flexible to different applications, by relaxing constraints on the parameters required to describe said multiple quadratic surfaces Q.

Thus, the DCS controller 112 may be configured to use a splitting approach consisting in adding a constraint where an electromagnetic wave scattered by the scattering surface 104 of the first DCS 102 is matched with an electromagnetic wave that reaches the scattering surface 104a of the second DCS 102a, as it will be described in the following.

In the exemplary applications of FIGS. 12a) to 12c), the structure of the electromagnetic wave 110 transmitted by the transmitter 108 may be a cylindrical cone with numerical aperture Ω. The structure of the electromagnetic wave 110 can be obtained by the DCS controller 112 from the position of the transmitter 108 and its antenna aperture, and from the position of the receiver 116 and its antenna aperture.

The structure of the desired electromagnetic wave 114 scattered by the first DCS 102 may comprise plane waves. The desired characteristic of the desired electromagnetic wave scattered by the DCS 102 may be obtained by the DCS controller 112 by signaling from the transmitter 108, or by signaling from the receiver 116.

Further, the one or more parameters of each of the first DCS 102 and the second DCS 102a may comprise at least one of the position of the respective DCS 102, 102a, the size of each of the scattering elements 106, 106a of the respective scattering surface 104, 104a of the DCS 102, 102a, and the total number of the scattering elements 106, 106a.

Paraboloid surfaces may satisfy the desired requirement based on the characteristic of the electromagnetic wave 110 transmitted by the transmitter 108, on the desired characteristic of the desired electromagnetic wave 114, and on the one or more parameters of the DCSs 102, 102a.

Thus, the DCS controller 112 may determine a first quadric surface Q₁ that describes a transformation of the electromagnetic wave 110 transmitted by the transmitter 108 to form a first desired electromagnetic wave scattered by the first DCS 102, and may determine a second quadric surface Q₂ that describes a transformation of the first desired electromagnetic wave scattered to form a second desired electromagnetic wave 114 scattered by the second DCS 102a.

Each of the first quadric surface Q₁ and the second quadric surface Q₂ may be a paraboloid that allows any electromagnetic wave from the infinite (far field) to be focused a respective focal point, or may enable any electromagnetic wave originating from their respective focal point to be transmitted as coming from the infinite (parallel wave).

The canonical equation for each of the first optimal quadric surface Q*₁ and the second optimal quadric surface Q*₂ may be given by Equation (13)

$$\frac{{x}^{2} + {y}^{2}}{2 {p}_{i}} - z = 0 ⇒ {x}^{2} + {y}^{2} = 2 {p}_{i} z \qquad ( 13 )$$

where pᵢ is a minimum distance of a focal point of the quadric surface i to its directrix, and i=1, 2 for the first DCS 102 and for the second DCS 102a, respectively.

For unicity, the first paraboloid of revolution with focal point TX (transmitter 108) and tangent to the first DCS 102 and the second paraboloid of revolution with focal point RX (receiver 116) and tangent to the second DCS 102a are considered, fixing p₁ and p₂.

The DCS controller 112 may then determine, based on the quadric surfaces Q₁ and Q₂, based on the one or more parameters of the first and second DCS 102, 102a, based on the characteristic of the electromagnetic wave 110 transmitted by the transmitter 108, a characteristic of the desired electromagnetic wave scattered by the scattering surface 104 of the first DCS 102, and based on the characteristic of the desired electromagnetic wave 114 scattered by the second scattering surface 104a of the second DCS 102a, a first optimal quadric surface Q*₁ and a second optimal quadric surface Q*₂ that describe a transformation to be applied by first DCS 102 and the second DCS 102a, respectively, to form the first desired electromagnetic wave and the second desired electromagnetic wave 114.

Then, the DCS controller 112 may control the scattering elements 106, 106a of the first and second DCS 102, 102a respectively, using the codeword 113, to form the desired electromagnetic wave scattered by the first scattering surface 104 of the first DCS 102 and the desired electromagnetic wave 114 scattered by the scattering surface 104a of the second DCS 102.

From the generalized form of the phase shift of Equation (6), the DCS controller 112 may then determine the phase shift for each of the scattering elements 106, 106a of the first DCS 102 and the second DCS 102a given in Equations (14) and (15),

$${ϕ}_{k}^{1} = \frac{2 π}{λ} ( ‖ \vec{T x {M}_{k}^{1}} ‖ + ‖ \vec{{M}_{k}^{1} {V}_{1}} ‖ - ‖ \vec{T x {U}_{1}} ‖ - ‖ {\vec{{U}_{1} V}}_{1} ‖ ) , \qquad ( 14 )$$

$${ϕ}_{k}^{2} = \frac{2 π}{λ} ( ‖ \vec{R x {M}_{k}^{2}} ‖ + ‖ \vec{{M}_{k}^{2} {V}_{2}} ‖ - ‖ \vec{R x {U}_{2}} ‖ - ‖ {\vec{{U}_{2} V}}_{2} ‖ ) \qquad ( 15 )$$

where Uᵢ and Vᵢ are points belonging to the optimal paraboloid surface Q*ᵢ and a corresponding region of interest, respectively, Mₖⁱ specifies the position of the k-th scattering element 106 in the i-th DCS 102, 102a, with=1, 2, \vec{AB} represents a vector between the two points A and B, and ∥.∥ is the Euclidian norm operator.

Then, the DCS controller 112 may control using the codeword 113, the scattering elements 106 of the scattering surface 104 of the first DCS 102 and the scattering elements 106a of the scattering surface 104a of the second DCS 102a to form the first desired electromagnetic wave and the second desired electromagnetic wave 114, respectively, for the applications depicted in FIGS. 12a) to 12c).

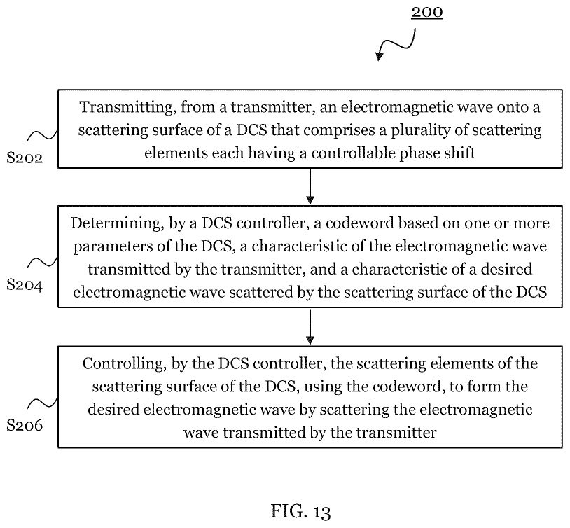

FIG. 13 shows an exemplary embodiment of a radio frequency method 200 according to this disclosure. The method 200 may be performed by the device 100 of FIG. 1 and FIG. 7 as disclosed above.

The method 200 comprises a step S202 of transmitting, from a transmitter 108, an electromagnetic wave 110 onto a scattering surface 104 of a digitally controllable scatterer, DCS 102 that comprises a plurality of scattering elements 106 each having a controllable phase shift.

The method 200 further comprises a step S204 of determining, by a DCS controller 112, a codeword 113 based on one or more parameters of the DCS 102, a characteristic of the electromagnetic wave 110 transmitted by the transmitter 108, and a characteristic of a desired electromagnetic wave 114 scattered by the scattering surface 104 of the DCS 102, wherein the codeword 113 determines a phase shift configuration for the plurality of scattering elements 106 of the scattering surface 104 of the DCS 102. The codeword 113 determines a phase shift configuration for the plurality of scattering elements 106 of the scattering surface 104 of the DCS 102.

Further, the method 200 comprises a step S206 of controlling, by the DCS controller 112, the scattering elements 106 of the scattering surface 104 of the DCS 102, using the codeword 113, to form the desired electromagnetic wave 114 by scattering the electromagnetic wave 110 transmitted by the transmitter 108.

The method 200 may further comprise actions according to the described aforementioned exemplary embodiments of the radio frequency device 100. Hence, the method 200 achieves the same advantages as the radio frequency device 100.

The present disclosure further provides a computer program product comprising a program code for carrying out, when implemented on a processor, the method 200 as shown in FIG. 13. The computer program may be included in a computer readable medium of the computer program product. The computer readable medium may comprise essentially any memory, such as a ROM (Read-Only Memory), a PROM (Programmable Read-Only Memory), a 15 EPROM (Erasable PROM), a Flash memory, an EEPROM (Electrically Erasable PROM), or a hard disk drive.

Another exemplary embodiment of a radio frequency method according to this disclosure may comprise determining, by a DCS controller, a codeword based on one or more parameters of a DCS, the DCS comprising a scattering surface that comprises a plurality of scattering elements each having a controllable phase shift, based on a characteristic of an electromagnetic wave_impinging onto the scattering surface of the DCS, and based on a characteristic of a desired electromagnetic wave scattered by the scattering surface of the DCS.

The method may further comprise controlling, by the DCS controller, the scattering elements of the scattering surface of the DCS, using the codeword, to form the desired electromagnetic wave by scattering the electromagnetic wave impinging onto the scattering surface of the DCS. The codeword determines a phase shift configuration for the plurality of scattering elements of the scattering surface of the DCS.

The electromagnetic wave impinging onto the scattering surface of the DCS can be generated by, for example but not limited to, a transmitter.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A radio frequency device (100) comprising:
a digitally controllable scatterer, DCS (102), comprising a scattering surface (104) that comprises a plurality of scattering elements (106) each having a controllable phase shift;
a transmitter (108), configured to transmit an electromagnetic wave (110) onto the scattering surface (104) of the DCS (102); and
a DCS controller (112) configured to:
determine a codeword (113) based on one or more parameters of the DCS (102), a characteristic of the electromagnetic wave (110) transmitted by the transmitter (108), and a characteristic of a desired electromagnetic wave (114) scattered by the scattering surface (104) of the DCS (102), wherein the codeword (113) determines a phase shift configuration for the plurality of scattering elements (106) of the scattering surface (104) of the DCS (102); and
control the scattering elements (106) of the scattering surface (104) of the DCS (102), using the codeword (113), to form the desired electromagnetic wave (114) by scattering the electromagnetic wave (110) transmitted by the transmitter (108).

2. The radio frequency device (100) according to claim 1, wherein the characteristic of the electromagnetic wave (110) transmitted by the transmitter (108) comprises at least one of a propagation vector and a structure of the electromagnetic wave (110) transmitted by the transmitter (108).

3. The radio frequency device (100) according to claim 1, wherein the characteristic of the desired electromagnetic wave (114) scattered by the scattering surface (104) of the DCS (102) comprises at least one of a desired propagation vector and a structure of the desired electromagnetic wave (114) scattered by the scattering surface (104) of the DCS (102).

4. The radio frequency device (100) according to claim 1, wherein the one or more parameters of the DCS (102) comprise at least one of a position of the DCS (102), an orientation of the DCS (102), a size of each of the scattering elements (106) of the scattering surface (104) of the DCS (102), and a total number of the scattering elements (106) of the scattering surface (104) of the DCS (102).

5. The radio frequency device (100) according to claim 1, wherein the DCS controller (112) is further configured to determine the characteristic of the electromagnetic wave (110) transmitted by the transmitter (108), or to obtain the characteristic of the electromagnetic wave (110) transmitted by the transmitter (108) by signaling from the transmitter (108); and/or
wherein the DCS (102) controller (112) is further configured to determine the characteristic of the desired electromagnetic wave (114) scattered by the scattering surface (104) of the DCS (102), or to obtain the characteristic of the desired electromagnetic wave (114) scattered by the scattering surface (104) of the DCS (102) by signaling from the transmitter (108).

6. The radio frequency device (100) according to claim 1, wherein a position of the transmitter (108) and a position and orientation of the DCS (102) are fixed relative to each other.

7. The radio frequency device (100) according to claim 1, wherein the DCS controller (112) is further configured to:
determine, based on a quadric surface Q that behaves as a perfect electric conductor, PEC, based on the characteristic of the electromagnetic wave (110) transmitted by the transmitter (108) and based on the characteristic of the desired electromagnetic wave (114) scattered by the scattering surface (104) of the DCS (102), an optimal quadric surface Q* that describes a transformation of the electromagnetic wave (110) transmitted by the transmitter (108) to form the desired electromagnetic wave (114) scattered by the scattering surface (104) of the DCS (102); and
determine a phase shift for each of the scattering elements (106) of the scattering surface (104) of the DCS (102) as a function of one or more parameters of the optimal quadric surface Q*.

8. The radio frequency device (100) according to claim 7, wherein the quadric surface Q has a canonical equation:
$${( - 1 )}^{{α}_{2}} {( \frac{x}{a} )}^{{α}_{1}} + {( - 1 )}^{{β}_{2}} {( \frac{y}{b} )}^{{β}_{1}} + {( - 1 )}^{{γ}_{2}} {( \frac{z}{c} )}^{{γ}_{1}} = {( - 1 )}^{τ} d ,$$
wherein a, b, c, d, α₁, α₂, β₁, β₂, γ₁, γ₂, and τ, are parameters of the quadric surface Q, with α₂, β₂, γ₂, τ∈{0,1}.

9. The radio frequency device (100) according to claim 7, wherein the DCS controller (112) is further configured to determine the phase shift for each of the scattering elements (106) of the scattering surface (104) of the DCS (102) based on a minimum distance between the optimal quadric surface Q* and the scattering surface (104) of the DCS (102).

10. The radio frequency device (100) according to claim 7, wherein the codeword (113) indicates the determined phase shift for each of the scattering elements (106) of the scattering surface (104) of the DCS (102) such that controlling the scattering elements (106) of the scattering surface (104) of the DCS (102), using the codeword (113), scatters the electromagnetic wave (110) transmitted by the transmitter (108) according to a reflection of the quadric surface.

11. The radio frequency device (100) according to claim 1, further comprising a target (116) that is illuminated by the desired electromagnetic wave (114) scattered by the scattering surface (104) of the DCS (102).

12. The radio frequency device (100) according to claim 11, wherein the target is a receiver (116) configured to receive the desired electromagnetic wave (114) scattered by the scattering surface (104) of the DCS (102).

13. The radio frequency device (100) according to claim 11, wherein the DCS controller (112) is further configured to:
obtain the characteristic of the desired electromagnetic wave (114) scattered by the scattering surface (104) of the DCS (102) by signaling from the target (116); or
obtain the characteristic of the desired electromagnetic wave (114) scattered by the scattering surface (104) of the DCS (102) by using information about the target (116).

14. A radio frequency method (200), comprising:
transmitting (S202), from a transmitter (108), an electromagnetic wave (110) onto a scattering surface (104) of a digitally controllable scatterer, DCS (102), that comprises a plurality of scattering elements (106) each having a controllable phase shift;
determining (S204), by a DCS controller (112), a codeword (113) based on one or more parameters of the DCS (102), a characteristic of the electromagnetic wave (110) transmitted by the transmitter (108), and a characteristic of a desired electromagnetic wave (114) scattered by the scattering surface (104) of the DCS (102), wherein the codeword (113) determines a phase shift configuration for the plurality of scattering elements (106) of the scattering surface (104) of the DCS (102); and
controlling (S206), by the DCS controller (112), the scattering elements (106) of the scattering surface (104) of the DCS (102), using the codeword (113), to form the desired electromagnetic wave (114) by scattering the electromagnetic wave (110) transmitted by the transmitter (108).

15. The radio frequency method (200) according to claim 14, further comprising:
determining, based on a quadric surface Q that behaves as a perfect electric conductor, PEC, based on the characteristic of the electromagnetic wave (110) transmitted by the transmitter (108) and based on the characteristic of the desired electromagnetic wave (114) scattered by the scattering surface (104) of the DCS (102), an optimal quadric surface Q* that describes a transformation of the electromagnetic wave (110) transmitted by the transmitter (108) to form the desired electromagnetic wave (114) scattered by the scattering surface (104) of the DCS (102); and
determining a phase shift for each of the scattering elements (106) of the scattering surface (104) of the DCS (102) as a function of one or more parameters of the optimal quadric surface Q*.

16. A non-transitory computer-readable storage medium comprising instructions which, when executed by a computer of a radio frequency device, cause the radio frequency device to:
transmit, from a transmitter (108), an electromagnetic wave (110) onto a scattering surface (104) of a digitally controllable scatterer, DCS (102), that comprises a plurality of scattering elements (106) each having a controllable phase shift;
determine, by a DCS controller (112), a codeword (113) based on one or more parameters of the DCS (102), a characteristic of the electromagnetic wave (110) transmitted by the transmitter (108), and a characteristic of a desired electromagnetic wave (114) scattered by the scattering surface (104) of the DCS (102), wherein the codeword (113) determines a phase shift configuration for the plurality of scattering elements (106) of the scattering surface (104) of the DCS (102); and
control, by the DCS controller (112), the scattering elements (106) of the scattering surface (104) of the DCS (102), using the codeword (113), to form the desired electromagnetic wave (114) by scattering the electromagnetic wave (110) transmitted by the transmitter (108).

17. The non-transitory computer-readable storage medium according to claim 16, further comprises instructions which, when executed by the computer of the radio frequency device, cause the radio frequency device to:
determine, based on a quadric surface Q that behaves as a perfect electric conductor, PEC, based on the characteristic of the electromagnetic wave (110) transmitted by the transmitter (108) and based on the characteristic of the desired electromagnetic wave (114) scattered by the scattering surface (104) of the DCS (102), an optimal quadric surface Q* that describes a transformation of the electromagnetic wave (110) transmitted by the transmitter (108) to form the desired electromagnetic wave (114) scattered by the scattering surface (104) of the DCS (102); and
determine a phase shift for each of the scattering elements (106) of the scattering surface (104) of the DCS (102) as a function of one or more parameters of the optimal quadric surface Q*.
